(19) United States
(12) Patent Application Publication
(10) Pub. No.: US 2025/0380010 A1
(43) Pub. Date: Dec. 11, 2025

(54) DISPLAY DEVICE AND MEDIA ASSET PLAYING METHOD

(71) Applicant: HISENSE ELECTRONICS TECHNOLOGY (SHENZHEN) CO., LTD, Guangdong (CN)

(72) Inventors: Xianzhi LUO, Guangdong (CN); Huase LU, Guangdong (CN); Biao ZHOU, Guangdong (CN); Yaohua WU, Guangdong (CN)

(21) Appl. No.: 19/300,952

(22) Filed: Aug. 15, 2025

Related U.S. Application Data
(63) Continuation of application No. PCT/CN2023/140315, filed on Dec. 20, 2023.

(30) Foreign Application Priority Data
May 19, 2023 (CN) 202310575869.8
Jul. 5, 2023 (CN) 202310817525.3

(51) Int. Cl. H04N 21/232; H04N 21/231

(52) U.S. Cl. CPC H04N 21/232; H04N 21/23106

(57) ABSTRACT

Some embodiments of the present application provide a display device and a media asset playing method. The method may comprise: in response to a playing instruction for media asset data, acquiring a data transport stream of the media asset data, wherein the data transport stream comprises MPU metadata, fragment metadata and MFU data; then detecting a transport order of the MPU metadata, the fragment metadata and the MFU data in the data transport stream; if the transport order is a target order, introducing the data transport stream into a player, so as to decode and play the data transport stream in real time by means of the player; and if the transport order is not the target order, encapsulating the data transport stream into a media transport packet in the target order, and introducing the media transport packet into the player.

### CROSS-REFERENCE TO RELATED APPLICATIONS

The present application is a continuation application of PCT/CN2023/140315 filed on Dec. 20, 2023, which claims the priority of Chinese patent application No. 202310575869.8, filed with China National Intellectual Property Administration on May 19, 2023, and Chinese patent application No. 202310817525.3, filed with China National Intellectual Property Administration on Jul. 5, 2023, the entire contents of which are incorporated by reference herein.

### TECHNICAL FIELD

The present application relates to the technical field of display apparatuses, and in particular to a display apparatus and a media asset playing method.

### BACKGROUND

Display apparatuses refer to terminal devices that can output specific display pictures, which can be terminal devices such as smart televisions (TVs), communication terminals, smart advertising screens, projectors, etc. Taking smart TVs as an example, smart TVs are TV products that are based on Internet application technology, have open operating systems and chips, have open application platforms, can realize two-way human-computer interaction functions, and integrate multiple functions such as audio and video, entertainment, and data to meet the diverse and personalized needs of users.

Display apparatuses can play different types of media asset data based on the protocol stack. For example, the media asset data of TV programs can be transmitted through the Advanced Television Systems Committee (ATSC) 3.0 protocol stack, which defines MPEG (Moving Picture Experts Group) Media Transport Protocol (MMTP) and Real-time Object Delivery Protocol for Unidirectional Transport (ROUTE). When playing media asset data through MMTP, the media asset data needs to be encapsulated into MMT data packages for the display apparatus to decode and play.

### SUMMARY

A display apparatus provided by an embodiment of the present application includes: a display, configured to display a picture and/or a graphic user interface; a user interface, configured to receive a command from a user; a communication device, configured to communicate with an external device based on a predetermined protocol; a memory, configured to store computer instructions and data associated with the display apparatus; and at least one processor, connected to the display, the user interface, the communication device, and the memory, and configured to execute the computer instructions to cause the display apparatus to: in response to a playing command for media asset data, acquire a data transport stream of the media asset data, where the data transport stream includes media processing unit (MPU) metadata, fragment metadata, and media fragmentation unit (MFU) data; detect a transport sequence of the MPU metadata, the fragment metadata, and the MFU data in the data transport stream; in response to the transport sequence being a target sequence, inject the data transport stream into a player to cause the player to perform decoding and playing on the data transport stream in real time; and in response to the transport sequence being not the target sequence, encapsulate the data transport stream as a media transport package based on the target sequence, and inject the media transport package into the player.

Another display apparatus provided by an embodiment of the present application includes: a display, configured to display a picture and/or a graphic user interface; a user interface, configured to receive a command from a user; a communication device, configured to communicate with an external device based on a predetermined protocol; a memory, configured to store computer instructions and data associated with the display apparatus; at least one processor, connected to the display, the user interface, the communication device, and the memory, and configured to execute the computer instructions to cause the display apparatus to: in response to a playing command for media asset data, receive a data transport stream of the media asset data, where the data transport stream includes MPU metadata, fragment metadata, and media MFU data; cache the data transport stream into a player cache region; and in response to that the MPU metadata and the fragment metadata are cached in the player cache region, decapsulate data in the player cache region and inject the data in the player cache region into the player.

A media asset playing method provided in an embodiment of the present application includes: in response to a playing command for media asset data, acquiring a data transport stream of the media asset data, where the data transport stream includes MPU metadata, fragment metadata, and MFU data; detecting a transport sequence of the MPU metadata, the fragment metadata, and the MFU data in the data transport stream; in response to the transport sequence being a target sequence, injecting the data transport stream into a player to cause the player to perform decoding and playing on the data transport stream in real time; and in response to the transport sequence being not the target sequence, encapsulating the data transport stream as a media transport package based on the target sequence, and injecting the media transport package into the player.

### BRIEF DESCRIPTION OF FIGURES

FIG. 1 is a schematic diagram of an operation scenario between a display apparatus and a control device according to embodiments of the present application.

FIG. 2 is a schematic diagram of a hardware configuration of a display apparatus according to embodiments of the present application.

FIG. 3 is a schematic diagram of a hardware configuration of a control device according to embodiments of the present application.

FIG. 4 is a schematic diagram of a software configuration of a display apparatus according to embodiments of the present application.

FIG. 5 is a schematic diagram of a connection relationship between a display apparatus and a server according to embodiments of the present application.

FIG. 6 is a schematic diagram of the architecture of the ATSC3.0 system protocol stack according to embodiments of the present application.

FIG. 7 is a schematic diagram of an architecture for transmitting a media transport package through an MMT protocol session according to embodiments of the present application.

FIG. 8 is a diagram showing a data sequence arrangement of MMT packages in a normal sequence according to embodiments of the present application.

FIG. 9 is a diagram showing a data sequence arrangement of MMT packages in an abnormal sequence according to embodiments of the present application.

FIG. 10 is a diagram showing a conventional process interaction between a protocol stack middleware and a player for transmitting Media Processing Unit (MPU) data according to embodiments of the present application.

FIG. 11 is a flow chart of a method for transmitting a media transport stream according to embodiments of the present application.

FIG. 12 is a flow chart of a media asset playing method according to embodiments of the present application.

FIG. 13 is a schematic diagram of a playing architecture of a display apparatus according to embodiments of the present application.

FIG. 14 is a diagram showing an optimization process interaction between a protocol stack middleware and a player for transmitting MPU data according to embodiments of the present application.

FIG. 15 is a schematic diagram of a process of performing data standard setting on a data transport stream according to embodiments of the present application.

FIG. 16 is a schematic diagram of a process of decapsulating data in a player cache region according to embodiments of the present application.

FIG. 17 is a flow chart of a data transport stream caching method according to embodiments of the present application.

FIG. 18 is a flow chart of a determination for decapsulating data in a player cache region according to embodiments of the present application.

FIG. 19 is a schematic diagram of an audio and video playing principle according to embodiments of the present application.

FIG. 20 is a signaling interaction diagram of an audio and video playing process performed by an underlying layer framework according to embodiments of the present application.

FIG. 21 is a hardware connection block diagram of some functional modules of a display apparatus 200 according to embodiments of the present application.

FIG. 22 is a flow chart of a media asset playing method performed by a display apparatus 200 according to embodiments of the present application.

FIG. 23 is another signaling interaction diagram of an audio and video playing process performed by an underlying layer framework according to embodiments of the present application.

FIG. 24 is another signaling interaction diagram of an audio and video playing process performed by an underlying layer framework according to embodiments of the present application.

FIG. 25 is a schematic diagram of a user interface of a display apparatus 200 according to embodiments of the present application.

FIG. 26 is another schematic diagram of a user interface of a display apparatus 200 according to embodiments of the present application.

FIG. 27 is another schematic diagram of a user interface of a display apparatus 200 according to embodiments of the present application.

FIG. 28 is another schematic diagram of a user interface of a display apparatus 200 according to embodiments of the present application.

FIG. 29 is another schematic diagram of a user interface of a display apparatus 200 according to embodiments of the present application.

FIG. 30 is another schematic diagram of a user interface of a display apparatus 200 according to embodiments of the present application.

FIG. 31 is another schematic diagram of a user interface of a display apparatus 200 according to embodiments of the present application.

FIG. 32 is a schematic diagram of a decoding principle of multiple pieces of target media asset data according to embodiments of the present application.

FIG. 33 is a schematic diagram of a specific application flow of a media asset playing method according to embodiments of the present application.

### DETAILED DESCRIPTION

In order to make the purpose, content and advantages of the embodiments of the present application clearer, the embodiments of the present application will be clearly and completely described below in conjunction with the drawings in the embodiments of the present application. Obviously, the described exemplary embodiments are only part of the embodiments of the present application, not all of the embodiments.

Based on the exemplary embodiments shown in the present application, all other embodiments obtained by ordinary technicians in this field without creative work are within the claimed scope of the present application. In addition, although the disclosure in the present application is introduced according to one or several exemplary examples, it should be understood that each aspect of the disclosure can also constitute a complete embodiment separately.

It should be understood that the terms “first”, “second”, “third”, etc., in the specification and claims of the present application and the above drawings are used to distinguish similar objects, and are not necessarily used to describe a specific order or sequence. It should be understood that the terms used in this way can be interchangeable under appropriate circumstances, for example, they can be implemented according to an order other than those given in the diagrams or descriptions of the embodiments of the present application.

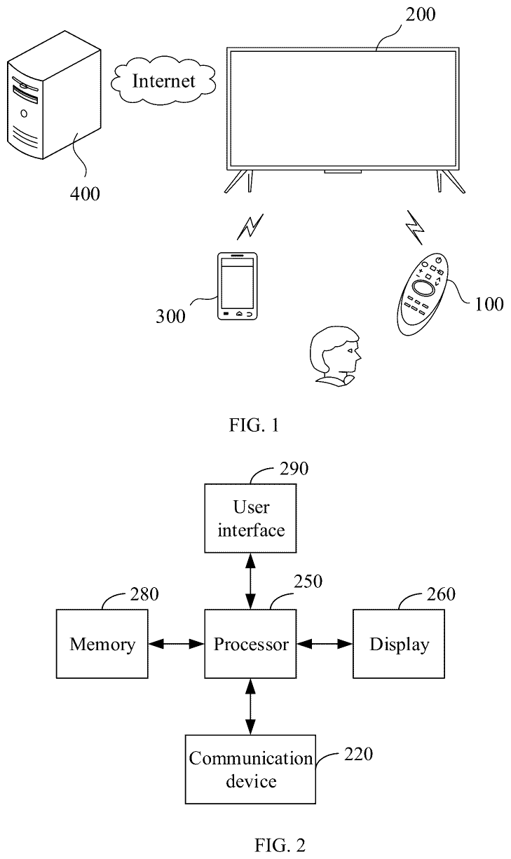

The display apparatus provided in the embodiments of the present application may have various implementation forms, for example, it may be a television, a smart television, a laser projection device, a monitor, an electronic bulletin board, an electronic table, etc. FIG. 1 and FIG. 2 are a specific implementation of the display apparatus of the present application.

FIG. 1 is a schematic diagram of an operation scenario between a display apparatus and a control device according to embodiments. As shown in FIG. 1, a user can operate a display apparatus 200 through a smart device 300 or a control device 100.

In some embodiments, the control device 100 may be a remote controller, and the communication between the remote controller and the display apparatus includes infrared protocol communication or Bluetooth protocol communication, and other short-range communication methods, and the display apparatus 200 is controlled wirelessly or wired. The user may control the display apparatus 200 by inputting user commands through buttons and voice input on the remote controller, and control panel input, etc.

In some embodiments, a smart device 300 (such as a mobile terminal, a tablet computer, a computer, a laptop computer, etc.) may also be used to control the display apparatus 200. For example, the display apparatus 200 is controlled using an application running on the smart device.

In some embodiments, the display apparatus may not use the above smart device or control device to receive commands, but may receive user control through touch or gestures.

In some embodiments, the display apparatus 200 can also be controlled in a manner other than the control device 100 and the smart device 300. For example, the user's voice command control can be directly received through a module for obtaining voice commands configured inside the display apparatus 200, or the user's voice command control can be received through a voice control device set outside the display apparatus 200.

In some embodiments, the display apparatus 200 also communicates data with the server 400. The display apparatus 200 may be allowed to communicate via a local area network (LAN), a wireless local area network (WLAN), and other networks. The server 400 may provide various content and interactions to the display apparatus 200. The server 400 may be one cluster or multiple clusters, and may include one or more types of servers.

As shown in FIG. 2, the display apparatus 200 includes: a display 260 configured to display a picture and/or a graphic user interface; a user interface 290 configured to receive a command from a user; a communication device 220 configured to communicate with an external device based on a predetermined protocol; a memory 280 configured to store computer instructions and data associated with the display apparatus; and at least one processor 250 connected to the display 260, the user interface 290, the communication device 220 and the memory 280, and configured to execute the computer instructions to cause the display apparatus 200 to: in response to a playing command for media asset data, acquire a data transport stream of the media asset data; the data transport stream including media processing unit (MPU) metadata, fragment metadata, and media fragmentation unit (MFU) data; detect a transport sequence of the MPU metadata, the fragment metadata, and the MFU data in the data transport stream; in response to the transport sequence being a target sequence, inject the data transport stream into a player to cause the player to perform decoding and playing on the data transport stream in real time; in response to the transport sequence being not the target sequence, encapsulate the data transport stream as a media transport package based on the target sequence, and inject the media transport package into the player.

In some embodiments, the processor 250 includes a video processor, an audio processor, a graphics processor, etc. The display apparatus may further include a RAM, a ROM, and a 1^{st} interface to an n^{th} interface for input/output.

The display 260 includes a display screen component for presenting pictures, and a driving component for driving picture display, which is used to receive picture signals output from a processor, and display video content and picture content, and a menu control interface component and a user control user interface.

The display 260 may be a liquid crystal display, an OLED display, or a projection display, and may also be a projection device and a projection screen.

The communication device 220 is a component for communicating with an external device or server according to various communication protocol types. For example, the communication device may include at least one of a Wifi module, a Bluetooth module, a wired Ethernet module, or other network communication protocol chips or near field communication protocol chips, or an infrared receiver. The display apparatus 200 can establish transmission and reception of control signals and data signals with the control device 100 or the server 400 through the communication device 220.

The user interface 290 may be used to receive a control signal from the control device 100 (e.g., an infrared remote controller, etc.).

In some embodiments, the display apparatus 200 may further include: a detector for collecting the signal of the external environment or the signal interacting with the outside. For example, the detector includes a light receiver, a sensor for collecting the intensity of ambient light; or, the detector includes a picture collector, such as a camera, which can be used to collect external environment scenes, user attributes or user interaction gestures, or, the detector includes a sound collector, such as a microphone, etc., for receiving external sounds.

In some embodiments, the display apparatus 200 may further include: an external device interface; the external device interface may include but is not limited to the following: any one or more interfaces such as a high-definition multimedia interface (HDMI), an analog or digital high-definition component input interface (component), a composite video input interface (CVBS), a Universal Serial Bus (USB) input interface, a red, green, and blue (RGB) port, etc. It may also be a composite input/output interface formed by the above multiple interfaces.

In some embodiments, the display apparatus 200 may further include: a tuner-demodulator; the tuner-demodulator receives broadcast television signals via wired or wireless reception, and demodulates audio and video signals, such as EPG data signals, from multiple wireless or wired broadcast television signals.

In some embodiments, the processor 250 and the tuner-demodulator may be located in different separate devices, that is, the tuner-demodulator may also be located in an external device, such as an external set-top box, of the main device where the processor 250 is located.

The processor 250 controls the operation of the display apparatus and responds to user operations through various software control programs stored in the memory. The processor 250 controls the overall operation of the display apparatus 200. For example, in response to a received user command for selecting a UI object to be displayed on the display 260, the processor 250 can perform operations related to the object selected by the user command.

The user may input a user command through a graphical user interface (GUI) displayed on the display 260, and the user input interface receives the user input command through the graphical user interface (GUI). Alternatively, the user may input a user command through a specific sound or gesture, and the user input interface recognizes the sound or gesture through a sensor to receive the user input command.

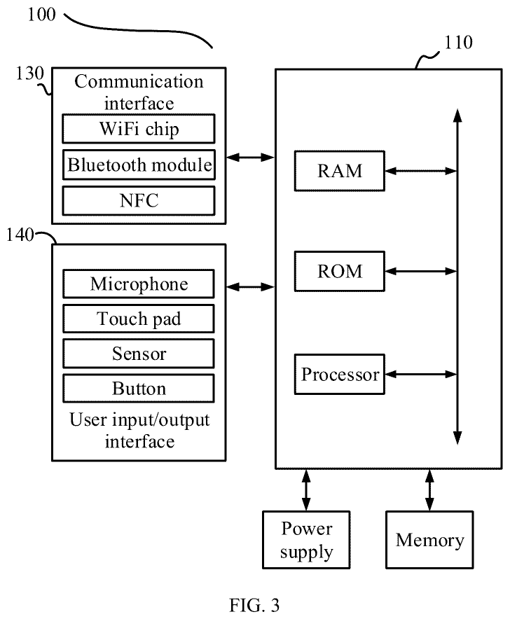

FIG. 3 is a block diagram of a configuration of a control device 100 according to embodiments of the present application. As shown in FIG. 3, the control device 100 includes a processor 110, a communication interface 130, a user input/output interface 140, a memory, and a power supply. The control device 100 can receive an input operation command from a user, and convert the operation command into a command that can be recognized and responded to by the display apparatus 200, and play the role of an interactive intermediary between the user and the display apparatus 200.

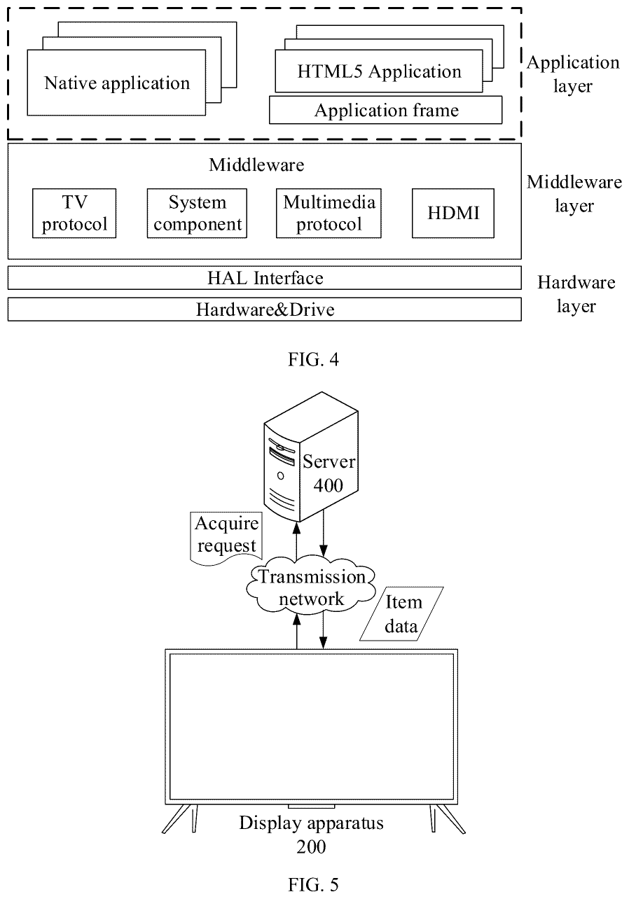

FIG. 4 is a software configuration diagram of a display apparatus 200 according to embodiments of the present application. In some embodiments, as shown in FIG. 4, the system of the display apparatus may include a kernel, a command parser (shell), a file system, and an application. The kernel, shell, and file system together constitute the basic operating system structure, which allows users to manage files, run programs, and use the system. After power-on, the kernel starts, activates the kernel space, abstracts hardware, initializes hardware parameters, etc., runs and maintains virtual memory, schedulers, signals, and inter-process communication (IPC). After the kernel starts, the shell and user applications are loaded. After startup, the application is compiled into machine code to form a process.

As shown in FIG. 4, the system of the display apparatus is divided into three layers, namely, the application layer, the middleware layer and the hardware layer from top to bottom. In some embodiments, the system of the display apparatus also includes a UI layer (not shown in the figure), which is located above the application layer and receives data transmission from the application layer to realize the picture presentation of the display 260.

The application layer mainly includes commonly used applications on TV and application frameworks. Common applications are mainly applications developed based on browsers, such as HTML5 APPs and native APPs.

The Application Framework is a complete program model that has all the basic functions, such as file access, data exchange, etc., as well as the using interfaces (toolbars, status bars, menus, dialog boxes) of these functions, required by standard application software.

Native apps can support online or offline, message push or local resource access.

The middleware layer includes various TV protocols, multimedia protocols, system components and other middleware. The middleware can use the basic services (functions) provided by the system software to connect various parts of the application system or different applications on the network, and can achieve the purpose of resource sharing and function sharing.

The hardware layer mainly includes HAL interface, hardware and driver. Among them, HAL interface is the unified interface for all TV chips to connect, and the specific logic is implemented by each chip. Drivers mainly include: audio driver, display driver, Bluetooth driver, camera driver, WIFI driver, USB driver, HDMI driver, sensor driver (such as fingerprint sensor, temperature sensor, pressure sensor, etc.), and power driver, etc.

In some embodiments, the application layer of the display apparatus 200 includes at least one application, such as a live TV application icon control, a video on demand application icon control, a media center application icon control, an application center icon control, a game application icon control, etc.

In some embodiments, the live TV application can provide live TV and broadcast TV through different signal sources. For example, the live TV application can use input from cable TV, wireless broadcast, satellite service or other types of live TV services to provide TV signals. The live TV application can display media asset data of the live TV signal on the display apparatus 200.

In some embodiments, the video on demand application can provide videos from different storage sources. Unlike the live TV application, the video on demand provides media asset data from certain storage sources. For example, the video on demand can come from a cloud storage server or from a local hard disk storage containing stored video programs.

In some embodiments, the media center application can provide an application for playing various multimedia contents. For example, the media center can provide services which are different from live TV or video on demand, and the user can access various pictures or audios through the media center application.

In some embodiments, the application center can provide and store various applications. The application can be a game, an application, or some other application related to a computer system or other device but can be run on a smart TV. The application center can obtain these applications from different sources, store them in a local storage, and then run them on the display apparatus 200.

It should be noted that the media asset data described in the embodiments of the present application includes audio data and video data, and may be one or a combination of the above two types of data.

Based on the above application, in order to play the corresponding media asset data in the display apparatus 200, as shown in FIG. 5, in some embodiments, the display apparatus 200 can communicate with the server 400 during use to achieve data interaction. For example, the user can trigger the display apparatus 200 to display a program list through an interactive command. The program list may include the title, start time, detailed description, program level and media asset items of programs in multiple channels. Each media asset item corresponds to a network address, and the network address is used to download the corresponding media asset data. The display apparatus 200 can obtain an acquisition request for acquiring media asset data from the server 400 in response to the interactive command input from the user. The user can request the server 400 to download the corresponding media asset data by selecting a media asset item in the program list for the display apparatus 200 to play.

After receiving the acquisition request, the server 400 can extract the media asset item included in the corresponding channel from the storage module according to the acquisition request, and feed the extracted media asset item information back to the display apparatus 200. The display apparatus 200 then generates a program list based on the media asset item information fed back by the server 400, and displays the program list on the display 260, providing a good program navigation mechanism for the display apparatus 200.

After the user selects the corresponding media item in the program list for playing, the display apparatus 200 can obtain media asset data from the server 400 in real time during the playing of the media item to form a media asset data stream, and continuously obtain media pictures through decoding, rendering and other processing.

In order to realize data interaction between the display apparatus 200 and the server 400, the display apparatus 200 needs to establish a communication connection with the server 400. For example, the display apparatus 200 and the server 400 can establish a communication connection through a transmission network, and the interactive data is transmitted between the display apparatus 200 and the server 400 through the transmission network.

In some embodiments, components for establishing a communication connection need to be provided on the display apparatus 200 and the server 400, respectively. That is, as shown in FIG. 5, a communication device 220 may be provided in the display apparatus 200, a communication module may be provided in the server 400, and the communication device 220 and the communication module may simultaneously support at least one of the same communication modes to establish a communication connection relationship. For example, the communication device 220 on the display apparatus 200 includes an optical fiber interface, so that the display apparatus 200 can be connected to the network through the optical fiber interface; meanwhile, the communication module of the server 400 also includes an optical fiber interface, and can also be connected to the network through the optical fiber interface to achieve a communication connection between the display apparatus 200 and the server 400.

It should be noted that the display apparatus 200 and the server 400 may also establish a communication connection relationship by other connection methods, such as wired broadband, wireless local area network, cellular network, Bluetooth, infrared, radio frequency communication, etc.

The connection relationship between the display apparatus 200 and the server 400 can be “multiple-to-one”, that is, multiple display apparatuses 200 can establish a communication connection with the same one server 400, so that the server 400 can provide services for multiple display apparatuses 200. The connection relationship between the display apparatus 200 and the server 400 can also be “multiple-to-multiple”, that is, multiple display apparatuses 200 can establish a communication connection with multiple servers 400, so that multiple servers 400 can provide different services for the display apparatus 200 respectively. Obviously, in some application scenarios, the connection relationship between the display apparatus 200 and the server 400 can also be “one-to-one”, that is, one server 400 specifically provides services for one display apparatus 200.

In order to provide services for the display apparatus 200, the server 400 may also include a storage module, which may store various resource data, information files, and control programs. In response to the user's interaction process, the display apparatus 200 may obtain different data from the storage module of the server 400. For example, when the display apparatus 200 orders a certain media item, it may send an acquisition request to acquire playing data to the server 400. After receiving the request, the server 400 may extract the media asset data to be played from the storage module and transmit the media asset data to the display apparatus 200, so that the display apparatus 200 may decode and display the media asset data. The control program stored in the storage module may be run by the control module of the server 400, so that the control module may perform corresponding functions according to the control program.

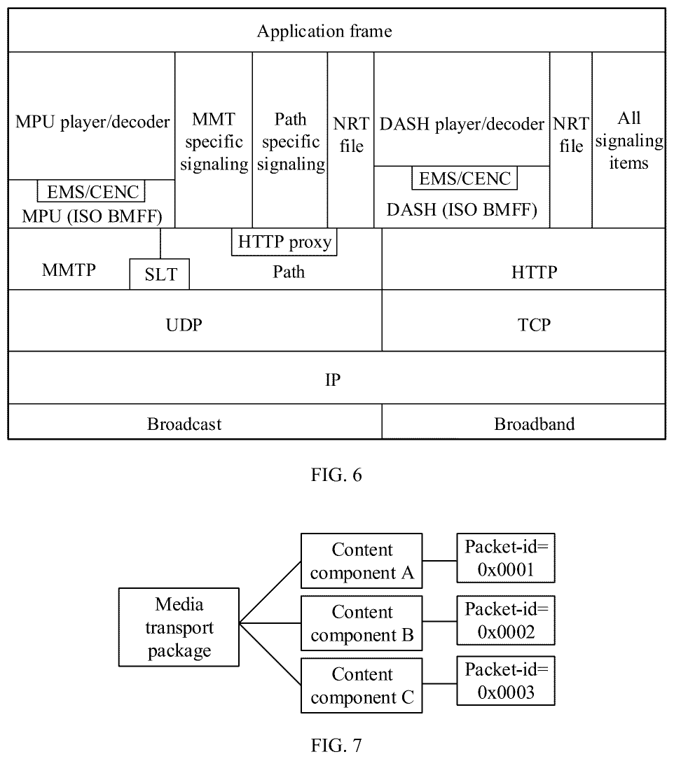

Based on the above display apparatus 200, in order to play the media asset data of the accessed channel, in some embodiments, the display apparatus 200 can transmit the media asset data corresponding to the channel accessed by the display apparatus 200 based on the Advanced Television Systems Committee (ATSC) 3.0 protocol stack to form a data transport stream of the media asset data. As shown in FIG. 6, the protocol layer of the ATSC3.0 protocol stack uses the full IP protocol. Due to the support of the bidirectional channel, the ATSC3.0 protocol stack can not only provide broadcast services for the display apparatus 200, but also provide interactive services for the display apparatus 200. Among them, the broadcast service is based on the UDP/IP protocol, and the interactive service is based on the TCP/IP protocol.

Therefore, the display apparatus 200 can transmit media asset data through the broadcast service provided by the ATSC3.0 protocol stack. In some embodiments, the broadcast service provided by the ATSC3.0 protocol stack includes the MPEG Media Transport Protocol (MMTP) and the Real-time Object delivery over Unidirectional Transport (ROUTE). Among them, MMTP is used to transmit the Media Processing Unit (MPU) and MMT specific signaling, and MPU is the basic encapsulation unit based on the ISO Basic Media File Format (ISO BMFF) in MPEG media transport; MMT specific signaling may include two types of signaling for consumption and presentation. ROUTE is used to transmit DASH segments, ROUTE specific signaling, and non-timing-sequence content. The DASH segment is based on the ISO basic media encapsulation format of HTTP-based dynamic adaptive streaming, and non-timing-sequence content may include non-timing-sequence media content, EPG data, etc.

It should be noted that the MMTP protocol package includes the ALP/IP/UDP/MMTP protocol, which can implement the data required for the specified MMTP program to be played. Among them, the ALP protocol refers to the link layer protocol in the ATSC3.0 protocol stack; the IP protocol refers to the protocol for interconnection between networks; and the UDP protocol refers to the User Datagram Protocol.

Furthermore, in some embodiments, non-timing-sequence content may also be directly transmitted via UDP. The signaling of the ATSC3.0 protocol stack may be distributed via MMTP and/or ROUTE. The bootstrap signaling information may be provided in the form of a service list table (SLT).

As shown in FIG. 6, in some embodiments, in order to implement heterogeneous services, one or more program elements in the display apparatus 200 are transmitted via a broadband path. At the broadband end of the display apparatus 200, the ATSC3.0 protocol stack uses MPEG DASH through the HTTP/TCP/IP protocol layer, and uses the ISO BMFF-based MPU and DASH files as broadcast and broadband transmission, encapsulation and synchronization formats.

In some embodiments, the display apparatus 200 transmits MMT data packages through an MMT protocol session, and uses a signaling information mode to transmit MMT signaling information. Each MMT protocol session needs to carry specific MMT signaling information and each component data transmitted by it. MMT signaling may include media presentation information (MPI) signaling, assumed receiver buffer model signaling, receiver buffer model removal signaling, and clock related information (CRI) signaling, etc. Among them, the media presentation information signaling includes all or part of the files of presentation information.

As shown in FIG. 7, in some embodiments, one MMT Asset corresponds to one content component and has a corresponding component ID, namely, packet-id, i.e., 0x0001, 0x0002, and 0x0003 are shown in FIG. 7. Each MMT Asset is a collection of one or more media processing units with the same one Asset ID, and the media processing units do not overlap in presentation time. One MMT package is a collection of one or more MMT Assets, such as Asset A, Asset B, and Asset C in FIG. 7. As shown in FIG. 7, the data transport stream of the media asset data is composed of one or more MMT packages (media transport packages), and the MMT packages do not overlap in presentation time.

It should be noted that the mapping information between the MMT package and the MMT protocol session is transmitted to the receiving end of the display apparatus 200 by the MMT signaling information.

In some embodiments, a complete MMT package is an MPU. The data in the MPU includes MPU metadata, fragment metadata, and MFU (Media Fragmentation Unit) data. Among them, an MFU is an I frame, and the I frame contains all the picture information, which can affect the playing picture presentation quality of the media asset data. When transmitting the media asset data, the above data is divided into UDP packages and sent. Each MPU contains a piece of MPU metadata, a piece of fragment metadata, and a number of MFUs. The display apparatus 200 can only play and display the received MFU data after receiving the MPU metadata and the fragment metadata.

Therefore, in some embodiments, when transmitting the MMT package, the display apparatus 200 also needs to detect the sequence of each data in the MMT package. Only when the sequence of the MMT package is MPU metadata, fragment metadata and MFU data, the display apparatus 200 can play the media asset data normally.

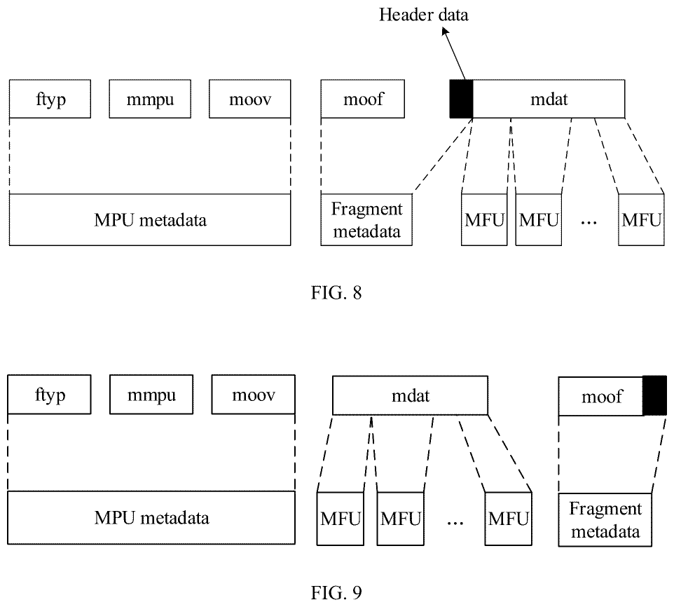

For example, as shown in FIG. 8, the MPU structure shown in FIG. 8 is an MMT package in a normal sequence. As can be seen from FIG. 8, the sequence of the MMT package is MPU metadata, fragment metadata, and MFU data. Then, when the MMT package is transmitted through the MMT protocol, there is no need to repackage the MMT package, and the complete MMT package can be directly transmitted to the player of the display apparatus 200.

It should be noted that the “mdat” header data containing MFU data in the MPU structure shown in FIG. 8 in the embodiment of the present application is also processed as fragment metadata.

Obviously, when the sequence of the MPU structure is an abnormal sequence, in order for the display apparatus 200 to play the MMT package of the media asset data normally, the display apparatus 200 needs to repackage the MMT package in the abnormal sequence to form an MMT package in the normal sequence. That is, in some embodiments, when the sequence of the MPU structure is the abnormal sequence, the display apparatus 200 repackages the MMT package in the normal sequence.

For example, as shown in FIG. 9, the MPU structure shown in FIG. 9 is a MMT package in a disordered sequence, and the display apparatus 200 needs to reassemble the MMT package in the sequence of MPU metadata-fragment metadata-MFU data (mpu metadata to fragment metadata to mdat) to form the MMT package in the normal sequence shown in FIG. 8.

Therefore, when the display apparatus 200 plays the media asset data, it needs to obtain the media asset data composed of multiple pieces of MPU data to continuously form the playing picture of the media asset data on the display 260. That is, in some embodiments, the display apparatus 200 interacts with the player through the protocol stack. When playing the media asset data, the display apparatus 200 starts the player through the protocol stack middleware, and meanwhile the player requests the MPU data from the protocol stack middleware to obtain the media asset data.

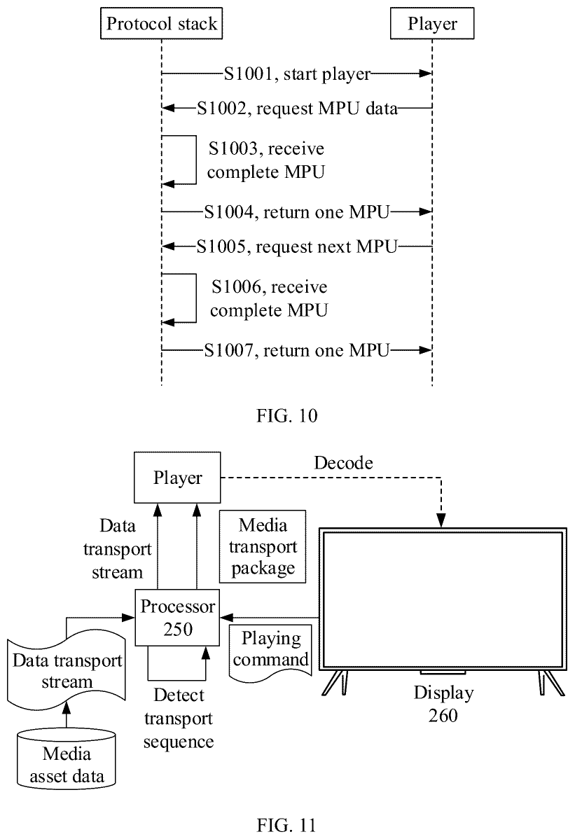

As shown in FIG. 10, a conventional process for transmitting MPU data between a protocol stack middleware and a player provided in embodiments of the present application includes the following.
S1001, the protocol stack sends a start player message to the player.
S1002, the player sends a request MPU data message to the protocol stack.
S1003, the protocol stack receives the complete MPU.
S1004, the protocol stack returns an MPU to the player.
S1005, the player requests the next MPU from the protocol stack.
S1006, the protocol stack receives the complete MPU.
S1007, the protocol stack returns an MPU to the player.

That is to say, in this embodiment, after receiving the request sent by the player, in response to the request sent by the player, the protocol stack middleware of the display apparatus 200 receives the MPU data corresponding to the media asset data sent by the server 400. After the protocol stack middleware receives the complete MPU data, it returns complete MPU data to the player. After receiving the complete MPU data, the player can perform decoding and playing on the MPU data, and meanwhile request the next MPU data from the protocol stack middleware.

However, it takes a certain amount of time for the protocol stack of the display apparatus 200 to obtain complete MPU data, which will slow down the picture output speed of the display apparatus 200. In this way, when the user watches channel programs through the display apparatus 200, a long waiting time will occur. For example, when the user continuously switches channels in the display apparatus 200, the display apparatus 200 needs to continuously obtain new signaling data and MPU data. Since the protocol stack of the display apparatus 200 needs to wait for complete MPU data, the problem of picture discontinuity will occur, resulting in a decrease in the playing efficiency of the media asset data. If the protocol stack of the display apparatus 200 does not wait for the complete MPU data, and directly injects the received MPU data into the player, the display apparatus 200 may not be able to play the media asset data normally due to the disorderly transmitted MPU data.

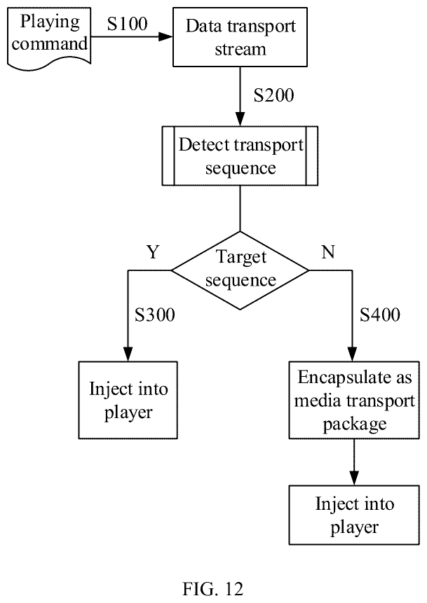

Based on the above application scenarios, in order to improve the problem of decreased playing efficiency of media asset data in the display apparatus 200, some embodiments of the present application provide a display apparatus 200, as shown in FIG. 11, including a display 260 and a processor 250. The display 260 is configured to display a playing picture of the media asset data. As shown in FIG. 12, the processor 250 is configured to execute computer instructions to cause the display apparatus to perform the following processing.
S100: in response to a playing command for media asset data, a data transport stream of the media asset data is acquired.

After receiving the playing command for the media asset data, the display apparatus 200 obtains the MMT package, i.e., MPU data, of the media asset data from the server 400 based on the protocol stack to form a data transport stream of the media asset data, where the data transport stream includes MPU metadata, fragment metadata, and MFU data.

The playing command for the media asset data can be generated based on the manipulation event of the upper-layer application. Therefore, in some embodiments, the display apparatus 200 monitors the manipulation event of the upper-layer application. The manipulation event can be a manipulation event of increasing the volume, a manipulation event of adjusting the brightness, a manipulation event of switching channels, and a manipulation event of accessing channels. After detecting the manipulation event of switching channels or accessing channels, the display apparatus 200 detects the target channel accessed by the display apparatus 200 in response to the manipulation event of switching channels or accessing channels.

For example, when the display apparatus 200 is turned on and starts broadcasting, the channel connected to it is DC a, and the target channel is DC a. The user uses the remote control device of the display apparatus 200 to adjust the channel to DC b, and the target channel is DC b. In other words, the target channel is the channel currently connected to the display apparatus 200, and it is not fixed.

After the display apparatus 200 detects the target channel, it queries the media asset data corresponding to the target channel and generates a playing command based on the media asset data. After the display apparatus 200 generates the playing command for the media asset data, it can, in response to the playing command, obtain the data transport stream of the media asset data.

When querying the media asset data corresponding to the target channel, in order to facilitate filtering of the media asset data, in some embodiments, the display apparatus 200 establishes a media asset transport channel according to the media transport protocol of the media asset data. For example, an MMT protocol session is created according to the MMT protocol. After the media asset transport channel is created, the media presentation information signaling is obtained through the media asset transport channel. Among them, the media presentation information signaling includes a presentation information table and a component description table. The above two tables are used for filtering the media asset data, and the component description table (User Service Dsecription, USD) includes the component ID, namely packet_id. Therefore, querying the media asset data based on the presentation information table and the component description table is to query the MPU data corresponding to the media asset data.

In some embodiments, the display apparatus 200 can obtain component data corresponding to the media asset data by matching the packet_id value of the MMT package. For example, the corresponding media asset data can be queried based on the packet_id recorded in the USD to form the MPU data of the media asset data.

Therefore, in some embodiments, when the display apparatus 200 obtains the data transport stream of the media asset data, it calls the channel interface of the protocol stack middleware and controls the target channel accessed by the display apparatus 200 through the channel interface, and then receives the media presentation information signaling and media asset data of the target channel.

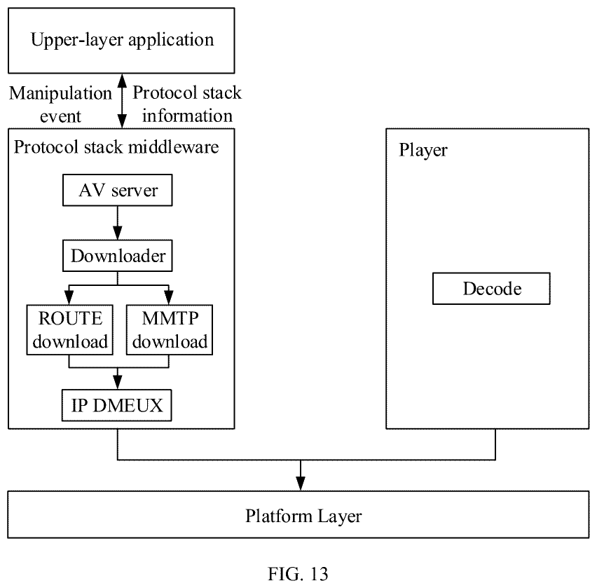

For example, as shown in FIG. 13, the display apparatus 200 transmits media asset data based on the ATSC3.0 protocol stack, where ATSC3.0 includes two data transport protocols, ROUTE and MMTP. After the user inputs a manipulation event for switching channels in the upper-layer application of the display apparatus 200, the display apparatus 200 calls the channel interface of the protocol stack middleware for switching channels, starts the switching process in the display apparatus 200, and receives the media presentation information signaling and media asset data of the target channel.

It is understandable that when switching to the target channel, the display apparatus 200 can not only receive media presentation signaling data, but also receive other signaling of more media asset data, such as CRI signaling, receiver buffer model removal signaling, and assumed receiver buffer model signaling, so that the display apparatus 200 can play the media asset data corresponding to the target channel.
S200: the transport sequence of MPU metadata, the fragment metadata and the MFU data in the data transport stream is detected.

After obtaining the data transport stream of the media asset data, the display apparatus 200 also detects the transport sequence of the data in the data transport stream. Since the display apparatus 200 cannot play the media asset data normally when the MPU data is in a disordered state, the display apparatus 200 needs to detect whether the transport sequence of the MPU data is normal in the protocol stack middleware when obtaining the data transport stream. That is to say, when the protocol stack middle layer of the display apparatus 200 receives the data transport stream, it detects whether the sequence of each data in the data transport stream is MPU metadata, fragment metadata, and MFU data, that is, the sequence shown in FIG. 8.

Therefore, the display apparatus 200 can set the sequence shown in FIG. 8 as the target sequence to measure whether the data transport stream of the media asset data is disordered through the target sequence. That is, in some embodiments, the target sequence is MPU metadata, fragment metadata, and MFU data.
S300: in response to the transport sequence being the target sequence, the data transport stream is injected into the player, so that the data transport stream is decoded and played in real time by the player.

Since the data transport stream of the media asset data is composed of multiple MMT packages, that is, multiple pieces of MPU data, in order to ensure that the MPU data corresponding to the media asset data can be played normally, the display apparatus 200 can compare the detected transport sequence with the target sequence after detecting the sequence of the data transport stream. In other words, the display apparatus 200 needs to detect the transport sequence of each MPU data in the data transport stream to determine whether the currently transmitted MPU data is in the target sequence.

Since the display apparatus 200 can only display and play the received MFU data after receiving the MPU metadata and the fragment metadata, when the transport sequence of the MPU data is the target sequence of MPU metadata, fragment metadata and MPU data, the MPU data can be played normally. In this way, in order to shorten the waiting time of the player, when the data transport stream of the media asset data is in the target sequence, the display apparatus 200 injects the current MPU data into the player, so that the player can perform decoding and playing on the data transport stream in real time, thereby improving the player's picture output speed.

For example, the display apparatus 200 detects that the transport sequence of the current data transport stream is MPU metadata, fragment metadata, and MPU data, indicating that the transport sequence of the current data transport stream is the target sequence.

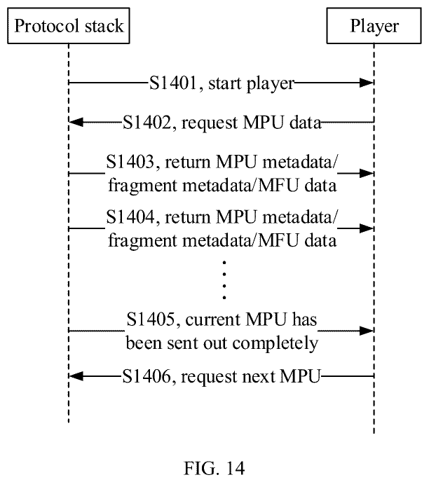

As shown in FIG. 14, an optimization process for transmitting MPU data between a protocol stack middleware and a player provided in embodiments of the present application includes the following.
S1401, the protocol stack sends a start player message to the player.
S1402, the player sends a request MPU data message to the protocol stack.
S1403, the protocol stack returns MPU metadata/fragment metadata/MFU data to the player.
S1404, the protocol stack returns MPU metadata/fragment metadata/MFU data to the player; and so on.
S1405, the protocol stack sends a current MPU sending completion message to the player.
S1406, the player requests the next MPU from the protocol stack.

That is to say, in this embodiment, the display apparatus 200 sends the received data transport stream to the player in real time, so that the player can decode and play the data transport stream in real time. After the current MPU data is received, the player requests the next MPU data from the protocol stack middleware, and the display apparatus 200 continues to detect the transport sequence of the MPU to switch the sending method of the MPU data based on the transport sequence. Obviously, the interaction method shown in FIG. 14 can shorten the waiting time of the player in the display apparatus 200 and improve the picture output speed of the display apparatus 200 compared with the interaction method shown in FIG. 10.
S400: in response to the transport sequence being not the target sequence, the data transport stream is encapsulated into a media transport package based on the target sequence, and the media transport package is injected into the player.

Similarly, in order to ensure that the data transport stream of the media asset data can be played normally, when the MPU data currently transmitted by the data transport stream is not in the target sequence, it means that the MPU data currently transmitted is arranged in a disordered sequence. Since the player cannot normally play the MPU data arranged in the disordered sequence, the MPU data needs to be re-packaged. Therefore, when the data transport stream of the media asset data is not in the target sequence, the display apparatus 200 re-packages the data transport stream into the media transport package(s) in the sequence shown in FIG. 8 based on the target sequence. In this way, the sequence of the media transport packages is MPU metadata, fragment metadata and MPU data, and the player of the display apparatus can display the playing picture of the media transport package normally. After the packaging is completed, the display apparatus 200 injects the packaged media transport package into the player of the display apparatus 200, so that the display apparatus 200 can decode and play the media transport package.

The process of display apparatus 200 receiving and detecting transport sequence is implemented based on protocol stack middleware. In order to enable the protocol stack middleware of display apparatus 200 to inject data into the player, the protocol stack middleware needs to establish a connection between the protocol stack middleware and the player before injecting data into the player.

Therefore, in some embodiments, the display apparatus 200 starts the media server of the protocol stack middleware, and establishes a connection relationship between the protocol stack middleware and the player through the media server. After the connection relationship between the protocol stack middleware and the player is established, the display apparatus 200 can call the player based on the connection relationship, and inject the data transport stream or media transport package into the player, so that the player can perform decoding and playing on the data transport stream or media transport package.

For example, as shown in FIG. 13, the protocol stack middleware of the display apparatus 200 includes an AV server module. The display apparatus 200 starts the AV server module to establish a connection with the player before transmitting the data transport stream of the media asset data. After the connection is established, the protocol stack middleware can inject the transportdata stream or media transport package of the media asset data into the player.

In order to facilitate the detection of the transport sequence of the transport data stream, in some embodiments, the FT (fragment type) field corresponding to the packet header of the fragment metadata is set to 0 or 1; the FT field corresponding to the packet header of the MFU data is set to 2. In this way, the boundary of the metadata or MFU data can be clearly characterized by the FT field, and meanwhile, the minimum information, such as the movie fragment sequence number and the sample sequence number, used to restore the association between the MFU data and the metadata is carried.

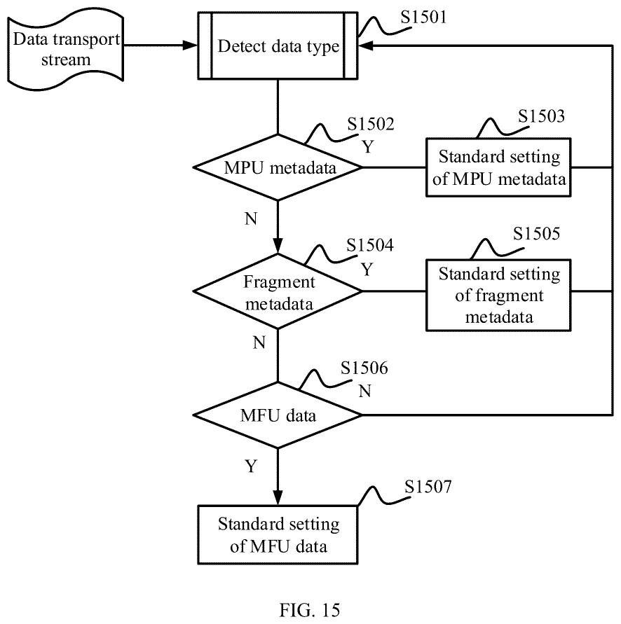

Therefore, as shown in FIG. 15, in some embodiments, the process of performing data standard setting on a data transport stream includes the following.
S1501, after receiving the data transport stream of media asset data, the protocol stack middleware of the display apparatus 200 further detects the data type of the data in the data transport stream.
S1502, whether the data type is MPU metadata is determined.
S1503, if the data type is MPU metadata, the display apparatus 200 sets based on the MPU metadata standard.
S1504, if the data type is not MPU metadata, whether the data type is fragment metadata is determined.
S1505, if the data type is the fragment metadata, the display apparatus 200 sets based on the fragment metadata standard.
S1506, if the data type is not fragment metadata, whether the data type is MFU data is determined.
S1507, if the data type is the MFU data, the display apparatus 200 sets based on the MFU standard.

That is, the protocol stack middleware of the display apparatus 200 sets the data transport stream according to the corresponding data standard, so that the display apparatus 200 can perform subsequent processing on the data transport stream.

After the protocol stack middleware of the display apparatus 200 injects data into the player, the player can decode and play the injected data. Therefore, in some embodiments, the display apparatus 200 initializes the decoder of the player and decodes the data transport stream through the decoder. After decoding the data transport stream, the display apparatus 200 calls the underlying resources to render the playing picture of the media asset data in the display 260 to form a continuous playing picture.

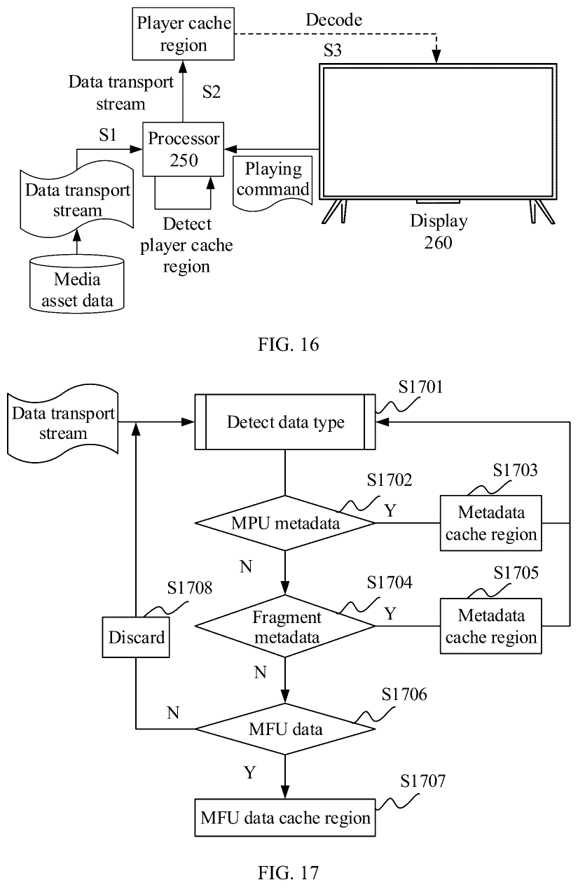

Based on the above embodiments, some embodiments of the present application further provide a display apparatus 200, including a display 260 and a processor 250. The display 260 is configured to display a playing picture of media asset data. As shown in FIG. 16, the processor 250 is configured to execute computer instructions to cause the display apparatus to perform the following processing.
S1: in response to a playing command for media asset data, a data transport stream of the media asset data is received.

After receiving the playing command for the media asset data, the display apparatus 200 obtains the MMT package, i.e., MPU data, of the media asset data from the server 400 based on the protocol stack to form a data transport stream of the media asset data, where the data transport stream includes MPU metadata, fragment metadata, and MFU data.
S2: the data transport stream is cached into the player cache region.

In order to speed up the decoding speed of the player, the display apparatus 200 can create a player cache region at the player end to cache the data transport stream of the media asset data in the player cache region. Therefore, by caching the data transport stream to the player end, the transmission efficiency of the data transport stream can be improved and the response speed of the display apparatus 200 can be accelerated.

In some embodiments, the player cache region includes a metadata cache region and an MFU data cache region, where the metadata cache region is used to cache MPU metadata and fragment metadata, and the MFU data cache region is used to cache MFU data.

Therefore, as shown in FIG. 17, the process of the data transport stream caching method provided in the embodiment of the present application includes the following.
S1701, when the display apparatus 200 caches the data transport stream to the player cache region, it also detects the data type of the data in the data transport stream.
S1702, whether the data type is MPU metadata is determined.
S1703, if the data type is the MPU metadata, the metadata is cached into the metadata cache region.

Among them, metadata includes the MPU metadata and the fragment metadata.
S1704, if the data type is not the MPU metadata, whether the data type is the fragment metadata is determined.
S1705, if the data type is the fragment metadata, the metadata is cached into the metadata cache region.

That is to say, when the data in the data transport stream is MPU metadata or fragment metadata, the MPU metadata or fragment metadata is cached in the metadata cache region on the player end.
S1706, if the data type is not the fragment metadata, whether the data type is the MFU data is determined.
S1707, similarly, if the data type is the MFU data, the MFU data is cached in the MFU data cache region. That is, when the data of the data transport stream is the MFU data, the MFU data is cached in the MFU cache region of the player end.
S1708, in addition, in some embodiments, during a process that the display apparatus 200 detects the data type of the data transport stream, when the data type of the data transport stream is neither metadata nor MFU data, the data is discarded to reduce the system resource consumption occupied by the player cache region in the display apparatus 200.
S3: when the MPU metadata and the fragment metadata are cached in the player cache region, the data in the player cache region is decapsulated and the data in the player cache region is injected into the player.

After the display apparatus 200 caches the data transport stream of the media asset data to the cache region of the player end, the data can be saved as two types of metadata and MFU data. Since the display apparatus 200 can only play and display the received MFU after receiving the MPU metadata and the fragment metadata, regardless of the sending sequence of the data transport stream, the display apparatus 200 decapsulates the data in the player cache region only after receiving the MPU metadata and the fragment metadata in the player cache region, and then injects the decapsulated data into the player, so that the player can decode and play the cached data in the player cache region.

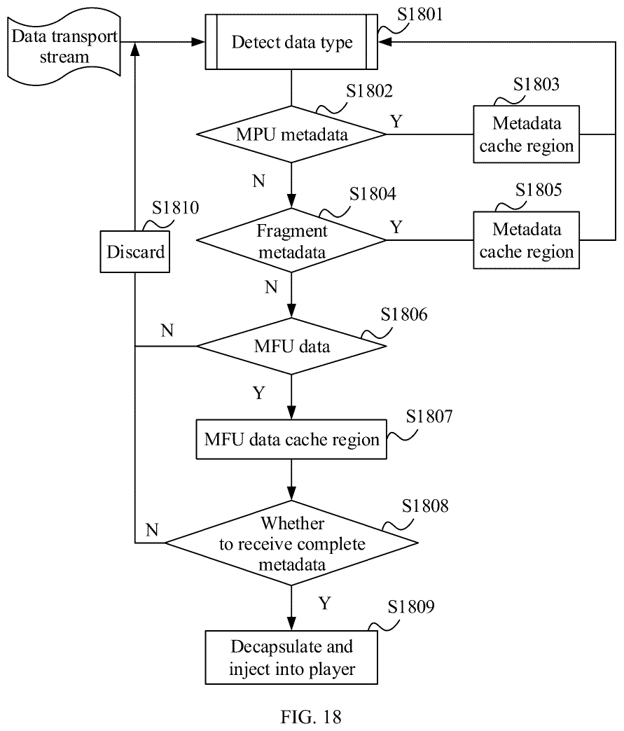

For example, as shown in FIG. 18, a determination process for decapsulating data in a player cache region provided in embodiments of the present application includes the following.
S1801, the protocol stack of the display apparatus 200 sends a data transport stream of media asset data to the player, and the display apparatus 200 detects the data type of the data transport stream.
S1802, whether the data type is MPU metadata is determined, if yes, execute step S1803; otherwise, execute step S1804.
S1803, the metadata is cached into the metadata cache region.
S1804, whether the data type is fragment metadata is determined; if yes, execute step S1805; otherwise, execute step S1806.
S1805, the metadata is cached into the metadata cache region.
S1806, whether the data type is MFU data is determined; if yes, execute step S1807; otherwise, execute step S1810.
S1807, the MFU data is cached into the MFU data cache region.

That is, in this embodiment, the metadata and MFU data are cached in the corresponding player cache region.
S1808, whether the player cache region has received complete metadata is detected, if yes, executing step S1809; otherwise, executing step S1810.
S1809, when complete metadata is received in the player cache region, the data in the player cache region is decapsulated so that the player can decode and play the data in the player cache region.
S1810, when the data type of the data transport stream is neither metadata nor MFU data, and the metadata received in the player cache region is not complete, the data is discarded to reduce the system resource consumption occupied by the player cache region in the display apparatus 200.

Based on the above display apparatus 200, some embodiments of the present application further provide a media asset playing method, as shown in FIG. 12, the method includes the following program steps.
S100: in response to a playing command for media asset data, a data transport stream of the media asset data is acquired; where the data transport stream includes MPU metadata, fragment metadata and MFU data.
S200: a transport sequence of MPU metadata, fragment metadata and MFU data in the data transport stream is detected.
S300: if the transport sequence is the target sequence, the data transport stream is injected into the player, so that the player can decode and play the data transport stream in real time.
S400: if the transport sequence is not the target sequence, the data transport stream is encapsulated into a media transport package based on the target sequence, and the media transport package is injected into the player.

It can be seen from the above embodiments that the display apparatus and media asset playing method provided in some embodiments of the present application can obtain the data transport stream of the media asset data in response to the playing command for the media asset data. Among them, the data transport stream includes MPU metadata, fragment metadata and MFU data. Then the transport sequence of the MPU metadata, fragment metadata and MFU data in the data transport stream is detected. If the transport sequence is the target sequence, the data transport stream is injected into the player so that the data transport stream is decoded and played in real time through the player. If the transport sequence is not the target sequence, the data transport stream is encapsulated into a media transport package based on the target sequence, and the media transport package is injected into the player. The method can directly inject the data transport stream into the player when the transport sequence of the data transport stream is the target sequence, which can speed up the picture output speed of the display apparatus and improve the playing efficiency of the media asset data.

In addition, in addition to the above embodiments, the present application also provides some other embodiments of display apparatuses and media asset playing methods, which prevent the display apparatus from remaining in a black screen and silent state for a long time when playing a type of broadcasting and television program that requires a long decoding time for video data, as described below.

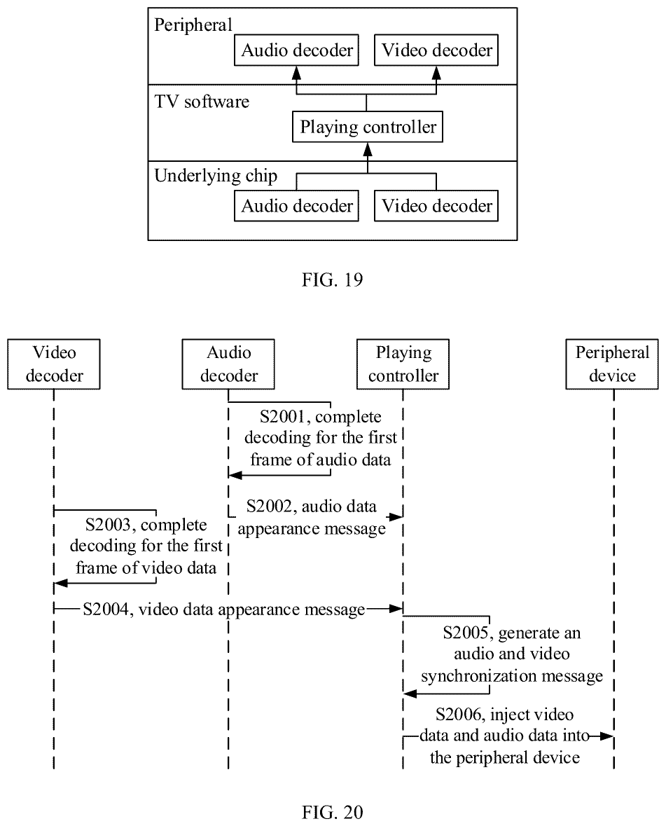

In some embodiments, the audio and video playing principle is shown in FIG. 19.

Referring to FIG. 20, the signaling interaction process of the underlying framework provided in the embodiment of the present application performing the audio and video playing process includes the following.
S2001, the audio decoder completes decoding of the first frame of audio data.
S2002, the audio decoder sends an audio data appearance message to the playing controller.
S2003, the video decoder completes decoding of the first frame of video data.
S2004, the video decoder sends a video data appearance message to the playing controller.
S2005, the playing controller generates an audio and video synchronization message.
S2006, the playing controller injects video data and audio data into the peripheral device.

That is to say, in this embodiment, when the video decoder completes decoding of the video data (here, it refers to the completion of decoding of the first frame of video data), it also reports the decoding status information to the monitoring interface and throws the video data appearance message to the playing processor of the middleware layer. When the audio decoder completes decoding of the audio data (here, it refers to the completion of decoding of the first frame of audio data), it also reports the decoding status information to the monitoring interface and throws the audio data appearance message to the playing processor of the middleware layer. The playing processor determines whether to control the display and speaker of the peripheral device to be turned on by monitoring the status information of the audio decoder and the video decoder. After receiving the audio and video synchronization message, the playing processor controls the display and speaker of the peripheral device to be turned on (calling the audio and video data interface, injecting video data into the display, and injecting audio data into the power amplifier for playing), so that the display plays the picture and the speaker plays the sound, and then the display apparatus can display the device picture and output the sound, thereby realizing the playing of broadcasting and television programs.

Although audio data can be decoded about 1 second after starting playing, the decoding time duration of video data is often longer than the decoding time duration of audio data. If the decoding time of video data of some broadcasting and television programs is too long, it will often cause the playing software to wait for a long time for the audio and video synchronization status message, and the corresponding display apparatus will remain in a black screen and silent state for a long time.

For example, for a still picture type of broadcasting and television program, the decoding time of the first frame of video data of this type of program is about 5 seconds, so the display apparatus needs to maintain a black screen and silent state for about 5 seconds to wait for the audio to be played synchronously. The effect presented to the user is that after the user enters the play command, the user waits for about 5 seconds before being able to see the picture and hear the sound on the display apparatus.

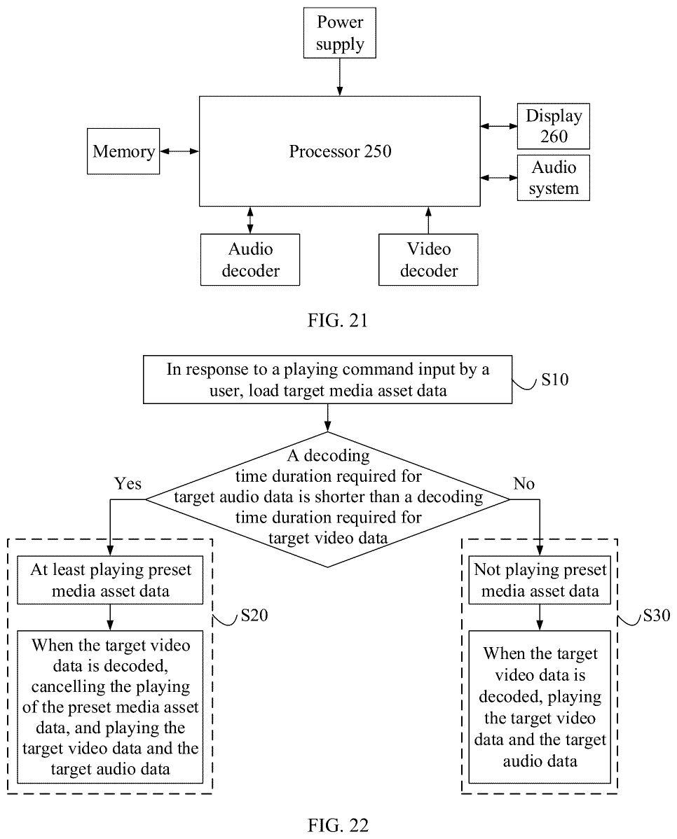

In view of the above problems, some embodiments of the present application provide a display apparatus 200. In order to facilitate the understanding of some embodiments of the present application, each step is described in detail below in combination with some specific embodiments and drawings. FIG. 21 is a hardware connection block diagram of some functional modules of the display apparatus 200 according to embodiments of the present application. FIG. 22 is a flow chart of the display apparatus 200 executing the media asset playing method according to embodiments of the present application.

As shown in FIG. 21, the functional modules of the display apparatus 200 involved in the embodiment of the present application mainly include: a processor 250, a power supply, a display 260, an audio system, a video decoder, an audio decoder, and a memory. The functional modules mentioned above are only for illustrating the modules described in the scheme, and are not intended to implement all the functional modules of the present application.

The processor 250 is the control and signal processing core of the entire display apparatus 200, and is responsible for controlling the system operation of the entire display apparatus 200, including receiving external picture signals, picture signal decoding, picture quality processing, and picture signal output; audio signal input, audio signal processing, and output of audio signals to the power amplifier device 500, controlling the operation of the backlight component, and ensuring the normal operation of peripheral devices or components such as Wi-Fi and Bluetooth.

The power supply is the power output module of the entire display apparatus 200, which provides power guarantee for all modules of the display apparatus 200. The display 260 is used to display the video picture; and the audio system is used to play the audio data. The video decoder is used to decode the received video data, and then transmit the decoded video data to the display 260 to display the video picture. The audio decoder is used to decode the received audio data, and then transmit the decoded audio data to the audio system, and the audio system plays the sound according to the decoded audio data. The memory can store video data and audio data that do not need to be decoded, or store video data and audio data with a short decoding time.

Based on the functional modules shown in FIG. 21, as shown in FIG. 22, the media asset playing method performed by the display apparatus 200 provided in the embodiment of the present application includes the following steps.
Step S10: in response to a playing command input from a user, target media asset data is loaded, where the target media asset data includes target audio data and target video data, and the decoding time duration required for the target audio data is shorter than the decoding time duration required for the target video data.

The present application can be applied to the scenario where the display apparatus 200 plays a broadcasting and television program, can be applied to the scenario where the display apparatus 200 plays a network television program, and can be applied to the scenario where the display apparatus 200 uses an HDMI (High Definition Multimedia) external media asset resource device to obtain media assets. For example, the HDMI interface of the display apparatus 200 is used to connect to a set-top box, a DVD player, a computer, etc., and then the display apparatus obtains media assets from the external set-top box, DVD player, computer, etc., media asset resource device, and then plays the obtained media assets on the display apparatus 200.

In the scenario of playing the broadcasting and television program, a playing command may be input by selecting a broadcasting and television program channel, and after obtaining the playing command, the server corresponding to the broadcasting and television program channel sends the media asset data corresponding to the playing command to the display apparatus 200. In the scenario of playing the network television program, a playing command may be input by selecting a certain network media asset on the media asset platform, and after obtaining the playing command, the server corresponding to the media asset platform sends the media asset data corresponding to the playing command to the display apparatus 200. In the scenario of obtaining media assets using the HDMI external media asset resource device, a playing command may be input by selecting a certain media asset icon in the application supported by the external device, and after obtaining the playing command, the external media asset resource device transmits the corresponding media asset data to the display apparatus 200.

In the above multiple scenarios, the media asset data acquired by the display apparatus 200 is the target media asset data in the embodiments of the present application. In different scenarios, after the display apparatus 200 acquires the target media asset data, the target media asset data needs to be decoded. The target media asset data includes target audio data and target video data, so if the target media asset data needs to be decoded, the target video data and the target audio data need to be decoded simultaneously.

Before decoding the target audio data and the target video data respectively, the target audio data and the target video data in the target media asset data need to be disassembled, or the target video data needs to be processed to extract the target audio data from the target video data. For example, the target video data is processed by FFMpeg (Fast Forward Mpeg, which is an open source computer program that records, converts digital audio and video, and can convert them into streams) to extract data in a 1600-sample, signed 16-bit little-endian pulse code modulation (PCM) format. In other words, the target video data and the target audio data in the target media asset data can be loaded separately, or the target audio data and the target video data can be loaded together.

The target audio data acquired by the display apparatus 200 is composed of audio frames. An audio frame is a data block with a fixed or non-fixed length at one end generated after audio data of a certain length is compressed by a certain compression algorithm. Such a data block is called a frame. The audio data before compression processing can be PCM (Pulse Code Modulation) data. For an audio file, after being encoded and compressed, the audio file is composed of a large number of audio frames and frame headers. Among them, the frame header includes some descriptive information, such as the encoding type, the number of channels, etc., of the audio frame.

Video is a continuous sequence of pictures, consisting of continuous frames, one frame is a picture. Due to the persistence effect of human vision, when a frame sequence is played at a certain rate, the human eye sees a video with continuous action. Since the similarity between consecutive frames is very high, in order to facilitate storage and transmission, the original video generally needs to be encoded and compressed to remove redundancy in the spatial and temporal dimensions. Video decoding basically performs the exact opposite process of video encoding.

Based on the above description, it can be known that audio frame and video frame are the basic units of encoding and decoding in audio and video technology. Both audio decoding and video decoding consume time. When decoding, the target audio data is decoded with audio frame as the basic unit, and the decoding is frame by frame; and likewise, the target video data is decoded with video frame as the basic unit, and the decoding is frame by frame. As shown in the audio and video playing principle diagram as shown in FIG. 19, the playing controller receives the audio and video synchronization message (audio data and video data have appeared) sent by the audio decoder and the video decoder, and then controls the display and the speaker to be turned on. Therefore, the decoding time duration required for the target audio data involved in the embodiments of the present application refers to the time consumed by decoding the first audio frame in the target audio data, and the decoding time duration required for the target video data involved in the embodiments of the present application refers to the time consumed by decoding the first video frame in the target video data.

That is to say, in the embodiment of the present application, when the audio decoder completes the decoding of the first audio frame, it generates an audio data appearance message, and when the video decoder completes the decoding of the first video frame, it generates a video data appearance message. When the decoding of the first video frame is completed and the decoding of the first audio frame is completed, an audio and video synchronization message is generated.

An audio frame usually only includes the data content of this frame, so the decoding time duration of an audio frame is relatively short. However, a video frame can be an I frame (intra-frame coded frame), a P frame (predictive coded frame), or a B frame (bidirectional predictive coded frame). An I frame is an independent frame that carries all the information. It can be decoded independently without referring to other pictures. It can be simply understood as a still picture. A P frame needs to be encoded by referring to the previous I frame. It represents the difference between the current frame and the previous frame (the previous frame may be an I frame or a P frame). When decoding, the difference defined by the current frame needs to be superimposed with the previously cached picture to generate the final picture. Compared with I frames, P frames usually occupy fewer data bits, but P frames have complex dependencies on the previous P and I reference frames. A B frame are also called bidirectional predictive coded frame, which means that the B frame records the difference between the current frame and the previous and next frames. In other words, to decode a B frame, it is necessary not only to obtain the previous cached picture, but also the picture after decoding, and to obtain the final picture by superimposing the previous and next pictures with the data of the current frame. B frames have a high compression rate, but they have high requirements for decoding performance.

The first frame in a video sequence is always an I frame, but since it is a key frame, it is an independent frame with all its own information, so the decoding time duration of the first video frame of the target video data is usually longer than the decoding time duration of the first audio frame of the target audio data. Some embodiments of the present application do not consider the situation where the decoding time duration required for the target audio data is longer than the decoding time duration required for the target video data.
Step S20: If the decoding time duration required for the target video data exceeds the decoding time duration threshold, at least the preset media asset data is played, and when the target video data is decoded, the playing of the preset media asset data is canceled, and the target video data and the target audio data are played, where the preset media asset data is media asset data that is pre-stored in the display apparatus and does not need to be decoded.
Step S30: If the decoding time duration required for the target video data does not exceed the preset decoding threshold, the preset media asset data is not played, and when the decoding of the target video data is completed, the target video data and the target audio data are played.

After acquiring the target media asset data, the display apparatus 200 can determine the required decoding time duration of the target audio data and the target video data included in the target media asset data based on the type of the target media asset data. For example, the target media asset data itself carries a media asset identifier, and then a configuration file is stored in the memory of the display apparatus 200. The configuration file includes the media asset identifier and the required decoding time duration of the target audio data and the target video data. Therefore, while the target media asset data is acquired, the required decoding time duration of the target audio data and the target video data can be found from the configuration file based on the media asset identifier of the target media asset data.

For example, the configuration file includes three media asset identifiers A, B, and C, and respectively records the decoding time duration required for the target audio data and the target video data corresponding to the media asset identifier A, the decoding time duration required for the target audio data and the target video data corresponding to the media asset identifier B, and the decoding time duration required for the target audio data and the target video data corresponding to the media asset identifier C. The media asset identifier A corresponds to one type of media asset data, the media asset identifier B corresponds to one type of media asset data, and the media asset identifier C corresponds to one type of media asset data.

If the target media asset data M1 loaded into the display apparatus 200 carries the media asset identifier A, it means that the target media asset data M1 belongs to the media asset data of the type of media asset identifier A. Then, the decoding time durations X1 and Y1 of the corresponding target video data and target audio data are found from the configuration file. If the target media asset data M2 loaded into the display apparatus 200 carries the media asset identifier B, it means that the target media asset data M2 belongs to the media asset data of the type of media asset identifier B. Then, the decoding time durations X2 and Y2 of the corresponding target video data and target audio data are found from the configuration file.

Since the decoding time duration required for the target video data is first located in the embodiments of the present application, which is greater than the decoding time duration required for the target audio data, it is only necessary to compare the decoding time duration required for the target video data with the decoding time duration threshold. For example, for the target media asset data M1 carrying the media asset identifier A, the decoding time duration X1 required for the target video data is compared with the decoding time duration threshold. If the decoding time duration X1 required for the target video data exceeds the decoding time duration threshold, if it is necessary to wait for the decoding of the target video data and the target audio data to be completed simultaneously, the user needs to wait for a long time when the display apparatus is in a black screen and silent state.

The above process is specifically implemented at the underlying layer as follows: the decoding time duration required by the audio decoder to decode the target audio data is Y1, for example, the decoding time duration required for the target audio data is 1 second, that is, the audio decoder takes 1 second to decode the first frame of the target audio data, and then the audio data appearance message can be thrown to the playing controller. The decoding time duration required by the video decoder to decode the target video data is X1, for example, the decoding time duration required for the target video data is 5 seconds, that is, the video decoder takes 5 seconds to decode the first frame of the target video data, and then the video data appearance message can be thrown to the playing controller. In other words, the playing controller needs to wait at least 5 seconds to receive the audio and video synchronization message. If the playing controller controls the display and speaker to be turned on after receiving the audio and video synchronization message, the user experience is that after entering the playing command, the display apparatus will be in a black screen and silent state for 5 seconds before the picture and sound can be played.

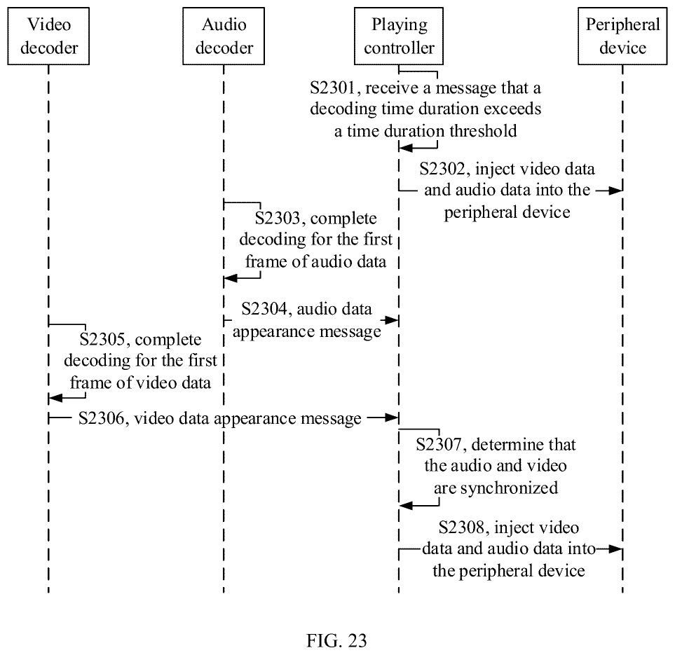

Referring to FIG. 23, a signaling interaction process of an underlying framework performing an audio and video playing process provided in embodiments of the present application includes the following.
S2301, the playing controller receives a message that the decoding time duration exceeds a time duration threshold.
S2302, the playing controller injects video data and audio data into the peripheral device.
S2303, the audio decoder completes decoding of the first frame of audio data.
S2304, the audio decoder sends an audio data appearance message to the playing controller.
S2305, the video decoder completes decoding of the first frame of video data.
S2306, the video decoder sends a video data appearance message to the playing controller.
S2307, the playing controller determines that the audio and video are synchronized.
S2308, the playing controller injects video data and audio data into the peripheral device.

It can be seen that, as shown in the audio and video playing signaling diagram of FIG. 23, the playing controller may receive a message that the decoding time duration required for the target video data exceeds the decoding time duration threshold sent by the chip layer, and the playing controller directly injects the preset media asset data into the peripheral device for playing. Then, when the audio decoder completes decoding the first frame of audio data, it sends the audio data appearance message to the playing controller. When the video decoder completes decoding the first frame of video data, it sends the video data appearance message to the playing controller. Then, based on the audio data appearance message and the video data appearance message, the playing controller determines that the audio and video are synchronized, and then injects the target media asset data into the peripheral device.

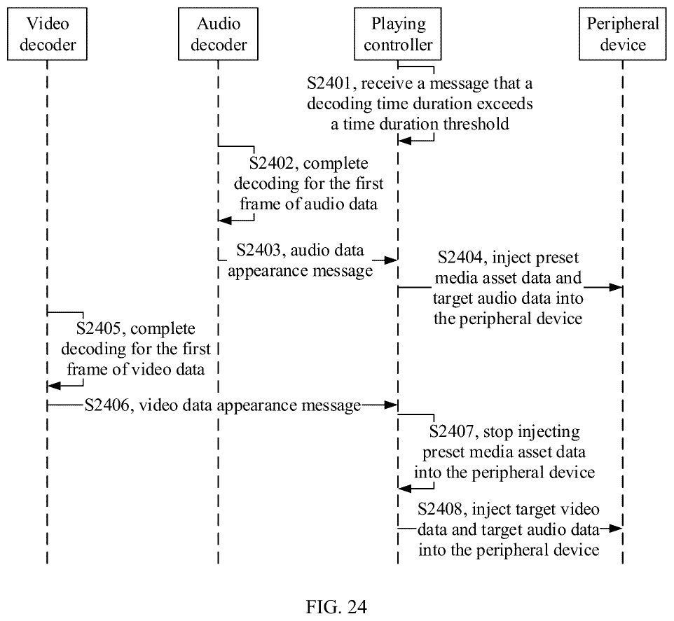

Referring to FIG. 24, a signaling interaction process of an underlying framework performing an audio and video playing process provided in embodiments of the present application includes the following.
S2401, the playing controller receives a message that the decoding time duration exceeds a duration threshold.
S2402, the audio decoder completes decoding of the first frame of audio data.
S2403, the audio decoder sends an audio data appearance message to the playing controller.
S2404, the playing controller injects preset media asset data and target audio data into the peripheral device.
S2405, the video decoder completes decoding of the first frame of video data.
S2406, the video decoder sends a video data appearance message to the playing controller.
S2407, the playing controller stops injecting preset media asset data into the peripheral device.
S2408, the playing controller injects target video data and target audio data into the peripheral device.

It can be seen that in the audio and video playing signaling diagram shown in FIG. 24, the playing controller may receive the massage that the decoding time duration required for the target video data exceeds the decoding time duration threshold sent by the chip layer, and then the playing controller waits for the audio data appearance message sent by the audio decoder. The playing controller determines the audio data appearance and the video data appearance, and injects the target audio data and preset media asset data (including only video data) into the peripheral device. Then, when the video decoder completes decoding the first frame of video data, the video data appearance message is sent to the playing controller. Then the playing controller stops injecting preset media asset data into the peripheral device, and injects the target video data and target audio data into the peripheral device.

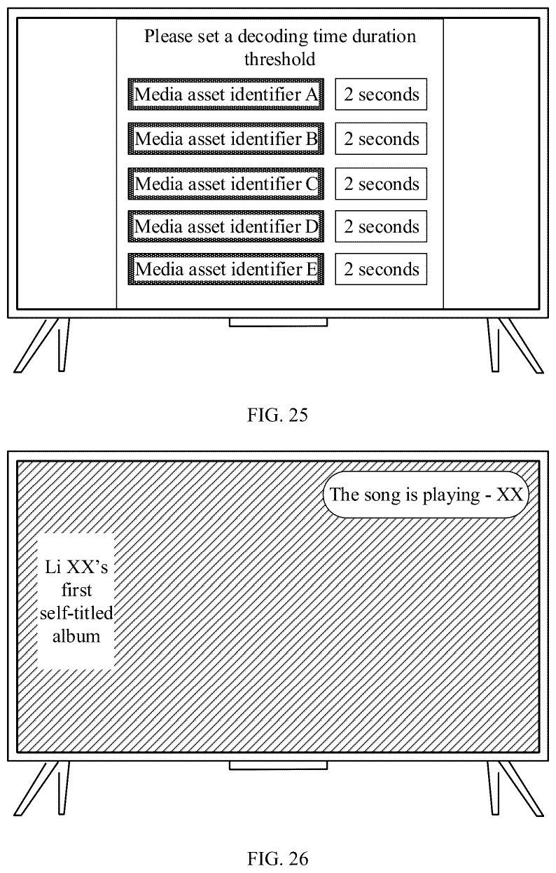

The decoding time duration threshold may be pre-stored in the display apparatus 200, or may be a parameter set by the user. On the user interface shown in FIG. 25, the user may set the decoding time duration threshold according to the actual usage scenario, and may also set different decoding time duration thresholds for different media asset types. For example, on the user interface shown in FIG. 25, a decoding time duration threshold N1 is set for target media asset data of the type corresponding to media asset identifier A, a decoding time duration threshold N2 is set for target media asset data of the type corresponding to media asset identifier B, and a decoding time duration threshold N3 is set for target media asset data of the type corresponding to media asset identifier C. The user may set different decoding time thresholds for different media asset types on the user interface shown in FIG. 25.

After loading the target media asset data, the display apparatus 200 searches the configuration file for the required decoding time duration of the corresponding target video data based on the media asset identifier carried by the target media asset data, and then searches for the corresponding decoding time duration threshold according to the media asset identifier, and compares the required decoding time duration of the target video data with the decoding time duration threshold.

In the above embodiment, if the decoding time duration threshold found is 2 seconds and the decoding time duration required for the target video data is 5 seconds, the decoding time duration required for the target video data exceeds the decoding time duration threshold, and thus the step of playing the preset media asset data can be performed. If the decoding time duration threshold found is 6 seconds and the decoding time duration required for the target video data is 5 seconds, the decoding time duration required for the target video data does not exceed the decoding time duration threshold, and thus the preset media asset data may not be played, and the step of playing the target video data and the target audio data simultaneously may be performed.

The above process is specifically implemented at the underlying layer as follows: the decoding time duration required by the audio decoder to decode the target audio data is Y1, for example, the decoding time duration required for the target audio data is 1 second, that is, the audio decoder takes 1 second to decode the first frame of the target audio data, and then the audio data appearance message is thrown to the playing controller. The decoding time duration required for the video decoder to decode the target video data is 5 seconds, that is, the video decoder takes 5 seconds to decode the first frame of the target video data, and then the video data appearance message is thrown to the playing controller. In other words, the playing controller needs to wait at least 5 seconds to receive the audio and video synchronization message.

If the decoding time duration threshold is 2 seconds, it is determined that the decoding time duration of the target video data exceeds the decoding time duration threshold, where the determination process may be performed by the underlying chip, and the underlying chip sends the determination result to the playing controller. The playing controller may control the display and/or speaker to be turned on, and then play the preset media asset data. The preset media asset data includes at least one of video data, picture data, or audio data.

If the preset media asset data only includes video data or picture data, the playing controller can only control the display to be turned on, that is, before playing the target video data and the target audio data, only the preset video data or the preset picture data are played on the display. If the preset media asset data includes video data and audio data, or includes picture data and audio data, the playing controller can control the display and the speaker to be turned on, that is, before playing the target video data and the target audio data, the preset video data or the preset picture data can be played on the display, and meanwhile, the speaker plays the sound based on the preset audio data. If the preset media asset data only includes audio data, the playing controller can only control the speaker to be turned on, that is, before playing the target video data and the target audio data, the speaker can play the sound based on the preset audio data.

The above three situations can ensure that when the decoding time duration required for the target video data exceeds the decoding time duration threshold, the preset video data and the preset audio data are played, or the preset video data is played, or the preset audio data is played, so as to avoid the display apparatus from remaining in a black screen and silent state for a long time. It should be noted that this in the embodiments of the present application avoids the display apparatus from remaining in a black screen and silent state for a long time. (By playing preset video data and preset audio data simultaneously, a long black screen and silent state is avoided; by playing only preset video data, a long black screen state is avoided but a long silent state does not need to be avoided; by playing only preset audio data, a long silent state is avoided but a long black screen state does not need to be avoided).

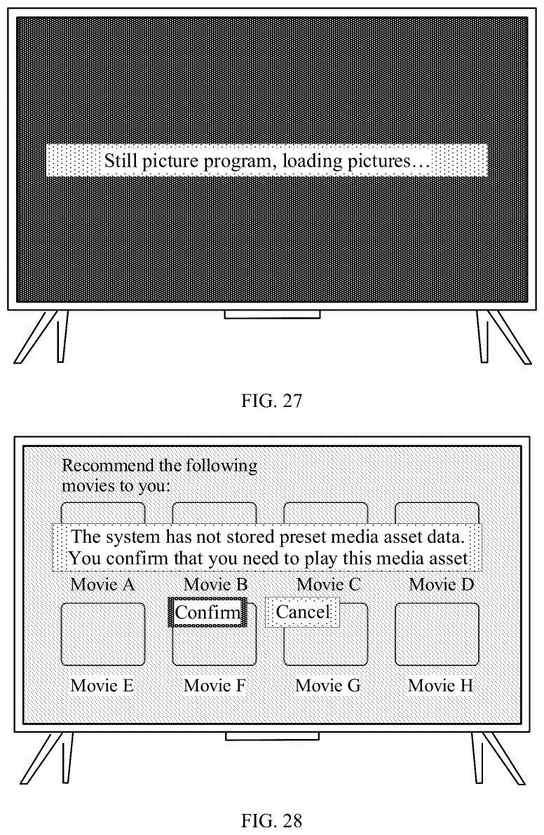

In some embodiments, after the target audio data is decoded, but the decoding time duration required for the target video data exceeds the decoding time duration threshold, the target audio data and the preset media asset data can be played simultaneously. For example, the target media asset data is a video data type of the still pictures type, in which a group of pictures are actually played, that is, the target video data is a group of pictures, not dynamic pictures, and the target audio data is an audio data of the music type. The user is actually not very concerned about the played video data, but is actually more concerned about the target audio data, so at this time, the target audio data can be played first (no need for the target audio data and the target video data to be synchronized), and the preset media asset data can be played. On the user interface shown in FIG. 26, before the target video data is loaded, the target audio data is played, and a still music cover picture is displayed. Or on the user interface shown in FIG. 27, before the target video data is loaded, the target audio data is played, and a prompt message “still pictures program, loading pictures . . . ” is displayed, from which the user can obtain that the target media asset data being played is of the still pictures type.

The above process is specifically implemented at the underlying layer as follows: the audio decoder needs 1 second of decoding time duration to decode the target audio data, that is, the audio decoder takes 1 second to decode the first frame of the target audio data, and then it can throw the audio data appearance message to the playing controller. The video decoder needs 5 seconds of decoding time duration to decode the target video data, that is, the video decoder takes 5 seconds to decode the first frame of the target video data, and then it can throw the video data appearance message to the playing controller. In other words, the playing controller needs to wait at least 5 seconds to receive the audio and video synchronization message. If the target media asset data type is determined to be still pictures, the playing controller can control the display and the speaker to be turned on simultaneously, and the display presents the music cover picture or prompt information, and the speaker plays the sound according to the target audio data.

It should be noted that in this case, after the display apparatus 200 obtains the target media asset data, it needs to wait for the target audio data to be decoded before it can play the sound. However, when presenting the music cover picture or prompt information, it can wait for the target audio data to be decoded, or it can present the music cover picture or prompt information when the target media asset data is obtained, and then play the target audio data after the target audio data is decoded. If the preset media asset data includes preset audio data and preset video data, the preset audio data and preset video data can be played simultaneously when the target media asset data is obtained, without waiting for the target audio data to be decoded.

If the decoding time duration required for the target video data exceeds the decoding time duration threshold, after at least the preset media asset data is played, if the target video data is decoded, in order to synchronize the audio data with the video data, the following playing situations exist.

If the target audio data is played while the preset media asset data is played, the preset media asset data is cancelled when the target video data is decoded. Then the target audio data is played from the first audio frame of the target audio data that has been played, and at the same time, the target video data is played from the first video frame, so that the target audio data and the target video data can be played synchronously.

If the target audio data is not played while the preset media asset data is played, the preset media asset data is cancelled when the target video data is decoded. Then the target audio data is played from the first audio frame of the target audio data, and meanwhile the target video data is played from the first video frame, so that the target audio data and the target video data can be played synchronously.

In some embodiments, if the decoding time duration required for the target video data exceeds the decoding time duration threshold, but the preset media asset data is not stored in the current system, a prompt message may be displayed to the user to prompt the user that the preset media asset data is not stored in the current system. For example, the playing command input from the user is obtained, and the media asset identifier carried by the playing command is determined to be a media asset type of the preset media asset data required to be played, so it is determined that the decoding time duration required for the target video data does not exceed the decoding time duration threshold. Meanwhile, it is also determined that the preset media asset data is not stored in the current system. At this time, as shown in FIG. 28, a prompt message “has not stored preset media asset data. You confirm that you need to play this media asset?” may be displayed on the user interface.

There are also “Confirm” and “Cancel” buttons below the prompt message. If the user selects the “Confirm” button, in response to the confirmation command input from the user by selecting the “Confirm” button, it is necessary to wait for the audio data and video data to be decoded, that is, it is necessary to show the user a black screen and silent state for a long time before the display will appear and the speaker will play the sound. If the user selects the “Cancel” button, in response to the cancellation command input from the user by selecting the “Cancel” button, it is possible to jump back from the user interface shown in FIG. 28 to the user interface for selecting media assets, for example, jump back to the main page of the media asset platform.

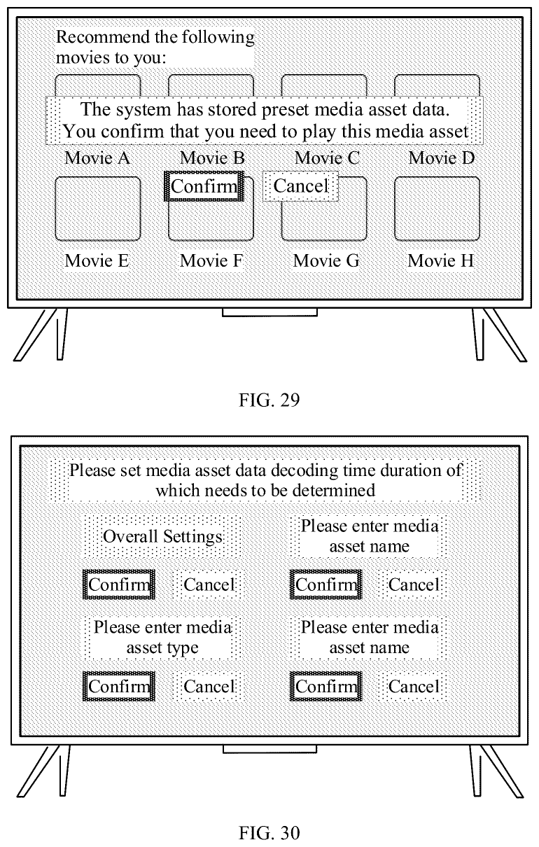

In some embodiments, if the decoding time duration required for the target video data exceeds the decoding time duration threshold, but preset media asset data is stored in the current system, a prompt message may also be displayed to the user to remind the user that the current system stores preset media asset data. If the current media asset is selected, the preset media asset data needs to be played before the selected media asset is played. For example, the playing command input for the user is obtained, and it is determined that the playing command carries a media asset identifier and belongs to the type of media asset that needs to play preset media asset data. Therefore, it is determined that the decoding time duration required for the target video data exceeds the decoding time duration threshold. Meanwhile, it is also determined that preset media asset data is stored in the current system. At this time, as shown in FIG. 29, a prompt message “The system has stored preset media asset data. You confirm that you need to play this media asset?” may be displayed on the user interface.

Below the prompt message, there are also a “Confirm” button and a “Cancel” button. If the user selects the “Confirm” button, in response to the confirmation command input from the user by selecting the “Confirm” button, it is necessary to wait for the audio data and the video data to be decoded, and the preset media asset data can be displayed to the user. If the user selects the “Cancel” button, in response to the cancellation command input from the user by selecting the “Cancel” button, the user interface shown in FIG. 29 can be jumped back to the user interface for selecting media assets, for example, jumping back to the main page of the media asset platform.

In some embodiments, in the setting function of the display apparatus 200, it is also possible to set whether to determine whether the decoding time duration of the target video data included in the media asset data exceeds the decoding time duration threshold when a certain media asset is clicked. The setting can be performed as a whole, uniformly for a certain type of media assets, or for a single media asset.

For example, the user interface shown in FIG. 30 includes an “Overall Settings” option, a “media asset type” option, and a “media asset name” option. Below each option, there are also a “Confirm” button and a “Cancel” button. If the user selects the “Confirm” button below the “Overall Settings” option, in response to the confirmation command input from the user, after the setting is successful, no matter which type of media asset the user chooses to play, it is necessary to first determine whether the decoding time duration required for the target video data exceeds the decoding time duration threshold. Then, if the decoding time duration required for the target video data exceeds the decoding time duration threshold, at least the preset media asset data is played. If the decoding time duration required for the target video data does not exceed the decoding time duration threshold, the preset media asset data is not played.

If the user enters the media asset identifier A in the input box of the “media asset type” option and selects the “Confirm” button below the “media asset type” option, in response to the confirmation command entered by the user, after the setting is successful, as long as the user chooses to play the media asset of the type corresponding to the media asset identifier A, it is necessary to first determine whether the decoding time duration required for the target video data exceeds the decoding time duration threshold. Then if the decoding time duration required for the target video data exceeds the decoding time duration threshold, at least the preset media asset data is played. If the decoding time duration required for the target video data does not exceed the decoding time duration threshold, the preset media asset data is not played. If the user selects other types of media, it is not necessary to determine whether the decoding time duration required for the target video data exceeds the decoding time duration threshold. It can directly wait for the decoding of the target video data and the target audio data to be completed, and perform the process of synchronously playing the target video data and the target audio data. Among them, the media asset of the type corresponding to the media asset identifier A can be of the type of media asset whose decoding time duration required for the target video data exceeds the decoding time duration threshold, which the user knows based on experience. The user interface shown in FIG. 28 only shows an input box for inputting the media asset type. In actual applications, multiple input boxes for inputting the media asset types can be provided. For example, the media asset of the type corresponding to media asset identifier A and the media asset of the type corresponding to media asset identifier B are selected simultaneously. Then, if the user chooses to play these types of media assets, whether the decoding time duration required for the target video data and the target audio data exceeds the decoding time duration threshold can be first determined.

If the user enters the media asset name XXX in the input box of the “media asset name” option, and selects the “Confirm” button below the “media asset name” option, in response to the confirmation command entered by the user, after the setting is successful, as long as the user chooses to play the media asset with the media asset name XXX, or the media asset with the media asset name containing XXX, it is necessary to first determine whether the decoding time duration required for the target video data exceeds the decoding time duration threshold. Then if the decoding time duration required for the target video data exceeds the decoding time duration threshold, at least the preset media asset data is played. If the decoding time duration required for the target video data does not exceed the decoding time duration threshold, the preset media asset data is not played. If the user chooses to play media asset with other names, it is not necessary to determine whether the decoding time duration required for the target video data exceeds the decoding time duration threshold. It can directly wait for the decoding of the target video data and the target audio data to be completed, and then perform the process of synchronously playing the target video data and the target audio data.

In some embodiments, if the decoding time duration required for the target video data exceeds the decoding time duration threshold, at least the preset media asset data is played. However, if the preset media asset data has not been played when the target video data is decoded, an option of continuing to play the preset media asset data or playing the target media asset data can also be provided.

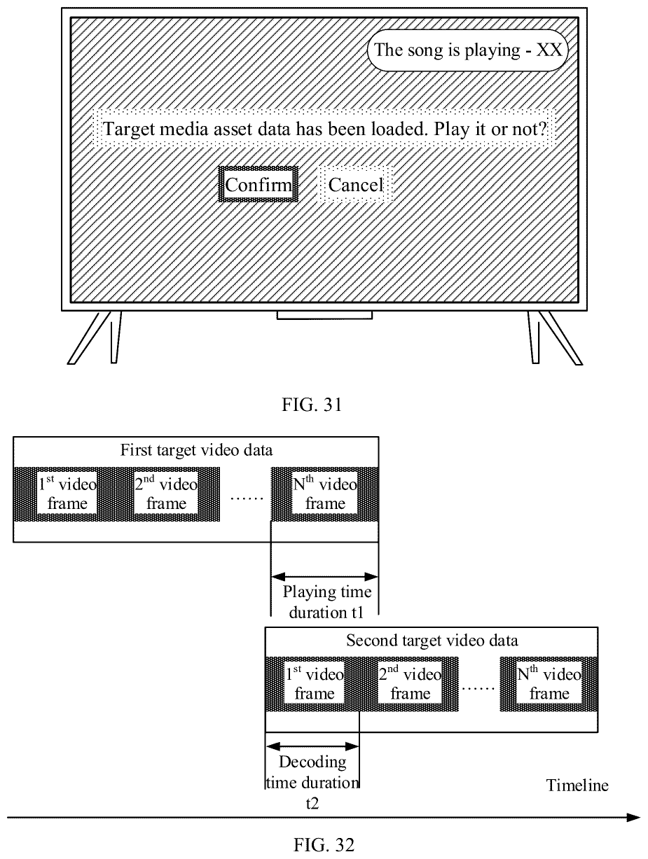

For example, if the target video data has been decoded and the playing of the preset media asset data has not been completed, a prompt message “Target media asset data has been loaded. Play it or not?” pops up on the user interface as shown in FIG. 31. A “Confirm” button and a “Cancel” button are also provided below the prompt message. If the user selects the “Cancel” button, in response to the cancellation command input from the user, the playing of the preset media asset data is canceled, and then the target media asset data is played. If the user selects the “Confirm” button, in response to the confirmation command input from the user, the playing of the preset media asset data is not canceled, but the preset media asset data is waited to be played, and then the target media asset data is played.

In some embodiments, if a plurality pieces of preset media asset data are stored in the display apparatus 200, the preset media asset data may be classified, and the preset media asset data may be classified based on the media asset type of the target media asset data. For example, the target media asset data includes the type corresponding to the media asset identifier A, the type corresponding to the media asset identifier B, the type corresponding to the media asset identifier C, etc. When classifying the preset media asset data, it may also be classified based on the type corresponding to the media asset identifier A, the type corresponding to the media asset identifier B, the type corresponding to the media asset identifier C, etc. In this way, if the decoding time duration required for the target video data exceeds the decoding time duration threshold, the preset media asset data of the same media asset type may be searched from the system for playing based on the media asset type of the target video data.

In some embodiments, if the playing command input from the user carries the media asset identifiers of multiple pieces of target media asset data, that is, the user may choose to play multiple pieces of target media asset data, and the multiple pieces of target media asset data can be played in sequence in the order in which they are selected, or in the order in which they are loaded. In this way, when multiple pieces of target media asset data are played in sequence, the intervals of the video frames included in different target media asset data may be different. When one piece of the target media asset data is played, due to the different video frame intervals, the next target media asset data may not have been loaded, and there may be a black screen and silent state for a certain period of time. Therefore, when different target media asset data are played continuously, not only for the first target media asset data, whether the decoding time duration required for the target video data exceeds the decoding time duration threshold needs to be determined, but also for other target media asset data whether the decoding time duration required for the target video data exceeds the decoding time duration threshold need to be determined.

For example, the playing command carries a media asset identifier A and a media asset identifier B, where the media asset identifier A corresponds to the first target media asset data, and the media asset identifier B corresponds to the second target media asset data; and the first target media asset data includes the first target video data and the first target audio data, and the second target media asset data includes the second target video data and the second target audio data. If the play sequence of the first target media asset data is before the play sequence of the second target media asset data, whether the decoding time duration of the first target video data exceeds the decoding time duration threshold is first determined, and if the decoding time duration of the first target video data exceeds the decoding time duration threshold, the preset media asset data is played, and when the decoding of the first target video data is completed, the first target video data and the first target audio data are played synchronously.

Then, when the first target media asset data is played, it is determined whether the difference between the playing time duration of a single video frame of the second target video data and the decoding time duration of the first target video data exceeds the decoding time duration threshold. As shown in the decoding principle diagram of FIG. 32, this is because when the last video frame of the first target video data is decoded, the video decoder starts decoding the first video frame of the second target video data, that is, when the last video frame of the first target media asset data is played, the first video frame of the second target video data is being decoded.

The playing time duration of a single video frame of the first target video data is t1. The decoding time duration of a single video frame of the second target video data is t2. If t1 is greater than or equal to t2, it means that the playing of the last video frame of the first target video data has not been completed yet, the first video frame of the second target video data has been decoded, or the first video frame of the second target video data has just been decoded when the playing of the last video frame of the first target video data is completed. At this time, regardless of whether the decoding time duration of the second target video data exceeds the duration threshold, a black screen and silent state will not appear, and there is no need to determine whether the decoding time duration of the second target video data exceeds the duration threshold.

If t1 is less than t2, it means that when the playing of the last video frame of the first target video data is completed, the decoding of the first video frame of the second target video data has not been completed, that is, the second target video data cannot be connected to the first target video data. At this time, it is necessary to determine whether the value of t2−t1 exceeds the decoding time duration threshold. If the value of t2−t1 exceeds the decoding time duration threshold, it is necessary to play the preset media asset data. If the value of t2−t1 does not exceed the decoding time duration threshold, it is not necessary to play the preset media asset data.

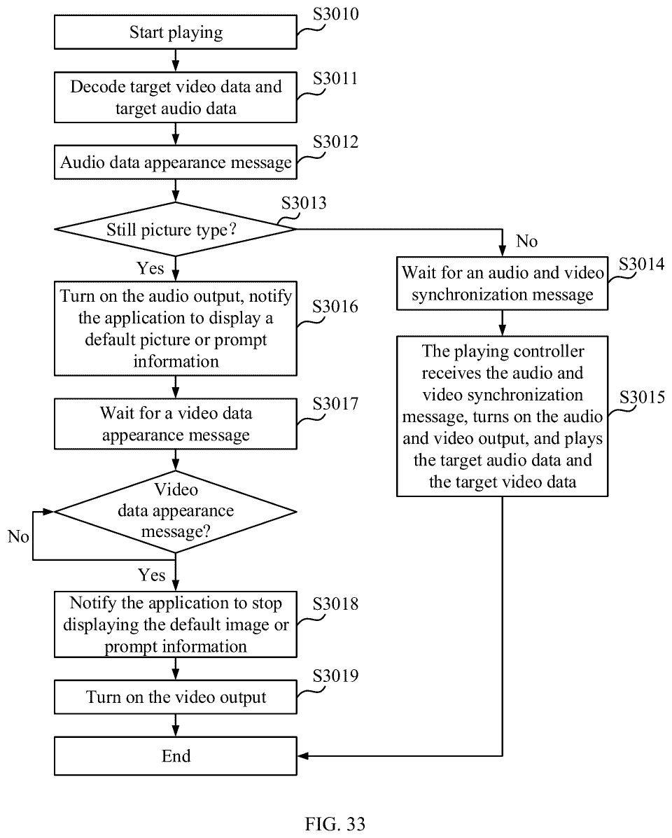

Based on the media asset playing method described in the above embodiment, as shown in the flowchart of FIG. 33, the following is a specific application process of the media asset playing method provided in the embodiment of the present application, which specifically includes the following.
S3010: the display apparatus 200 is started to prepare to play media asset data.
S3011: after acquiring the target media asset data, the decoding of the target video data and target audio data included in the target media asset data is started.
S3012: after the target audio data is decoded, the underlying chip sends an audio data appearance message to the playing controller.
S3013: whether it is a media asset of still picture type is determined, if not, execute step S3014, if yes, execute step S3016.
S3014: the audio and video synchronization message is waiting.
S3015: the playing controller has received the audio and video synchronization message, turns on the audio and video output, and plays the target audio data and the target video data.
S3016: the audio output is turned on, the target audio data is played, and the application is notified to display a default picture or prompt information.
S3017: a video data appearance message is waiting. If the video data appearance message is received, execute step S3018. If no video data appearance message is received, continue to execute step S3017.
S3018: the application is notified to stop displaying the default picture or prompt information.
S3019: the video output is turned on and the target video data is played.

The same and similar parts between the various embodiments of the present application can be referenced to each other and will not be described again here.

Those skilled in the art can clearly understand that the technology in the embodiments of the present application can be implemented by means of software plus a necessary general hardware platform. Based on this understanding, the part of the embodiments of the present application that is essentially or contributes to the relevant technology can be embodied in the form of a software product, and the computer software product can be stored in a storage medium, such as ROM/RAM, a disk, an optical disk, etc., including a number of instructions for a computer device (which can be a personal computer, a server, or a network device, etc.) to execute the methods of various embodiments of the present invention or certain parts of the embodiments.

For the convenience of explanation, the above description has been made in conjunction with specific embodiments. However, the above exemplary discussion is not intended to be exhaustive or limit the embodiments to the specific forms disclosed above. According to the above teachings, various modifications and variations can be obtained. The selection and description of the above embodiments are to better explain the principles and practical applications, so that those skilled in the art can better use the embodiments and various different variations of the embodiments suitable for specific use considerations.

What is claimed is:

1. A display apparatus, comprising:
a display, configured to display a picture and/or a graphic user interface;
a user interface, configured to receive a command from a user;
a communication device, configured to communicate with an external device based on a predetermined protocol;
a memory, configured to store computer instructions and data associated with the display apparatus; and
at least one processor, connected to the display, the user interface, the communication device, and the memory, and configured to execute the computer instructions to cause the display apparatus to:
in response to a playing command for media asset data, establish a media asset transport channel based on a media transport protocol of the media asset data;
acquire media presentation information signaling through the media asset transport channel, wherein the media presentation information signaling comprises a presentation information table and a component description table;
query the media asset data based on the presentation information table and the component description table to acquire a data transport stream of the media asset data, wherein the data transport stream comprises media processing unit (MPU) metadata, fragment metadata, and media fragmentation unit (MFU) data;
detect a transport sequence of the MPU metadata, the fragment metadata, and the MFU data in the data transport stream;
in response to the transport sequence being a target sequence, inject the data transport stream into a player to cause the player to perform decoding and playing on the data transport stream in real time; and
in response to the transport sequence being not the target sequence, encapsulate the data transport stream as a media transport package based on the target sequence, and inject the media transport package into the player.

2. The display apparatus according to claim 1, wherein the at least one processor is further configured to execute the computer instructions to cause the display apparatus to:
monitor a manipulation event of an upper-layer application;
in response to the manipulation event of switching a channel or accessing a channel, detect a target channel accessed by the display apparatus;
query the media asset data corresponding to the target channel; and
generate the playing command based on the media asset data.

3. The display apparatus according to claim 1, wherein the at least one processor is further configured to execute the computer instructions to cause the display apparatus to, when acquiring the data transport stream of the media asset data,
call a channel interface of a protocol stack middleware;
control a target channel accessed by the display apparatus through the channel interface; and
receive the media presentation information signaling and media asset data of the target channel.

4. The display apparatus according to claim 1, wherein the at least one processor is further configured to execute the computer instructions to cause the display apparatus to:
start a media server of a protocol stack middleware;
establish a connection relationship between the protocol stack middleware and the player through the media server; and
call the player based on the connection relationship, and inject the data transport stream or the media transport package into the player.

5. The display apparatus according to claim 1, wherein the at least one processor is further configured to execute the computer instructions to cause the display apparatus to, when decoding and playing the data transport stream,
initialize a decoder of the player;
decode the data transport stream by the decoder; and
call a underlying resource to render a playing picture of the media asset data on the display.

6. The display apparatus according to claim 1, wherein the target sequence is the MPU metadata, the fragment metadata, and the MFU data in sequence.

7. The display apparatus according to claim 1, wherein the at least one processor is further configured to execute the computer instructions to cause the display apparatus to:
in response to the playing command for the media asset data, receive the data transport stream of the media asset data;
cache the data transport stream into a player cache region; and
in response to that the MPU metadata and the fragment metadata are cached in the player cache region, decapsulate data in the player cache region and inject the data in the player cache region into the player.

8. The display apparatus according to claim 7, wherein the player cache region comprises a metadata cache region and a MFU data cache region, and the at least one processor is further configured to execute the computer instructions to cause the display apparatus to, when the data transport stream is cached in the player cache region,
detect a data type of data in the data transport stream;
in response to the data type being metadata, cache the metadata in the metadata cache region, wherein the metadata comprises the MPU metadata and the fragment metadata; and
in response to the data type being MFU data, cache the MFU data in the MFU data cache region.

9. The display apparatus according to claim 1, wherein the at least one processor is further configured to execute the computer instructions to cause the display apparatus to play and display the MFU data after receiving the MPU metadata and the fragment metadata.

10. The display apparatus according to claim 8, wherein the at least one processor is further configured to execute the computer instructions to cause the display apparatus to, when the data type of data in the data transport stream is neither metadata nor MFU data and the metadata received in the player cache region is not complete, discard the data in the data transport stream.

11. A media asset playing method, comprising:
in response to a playing command for media asset data, establishing a media asset transport channel based on a media transport protocol of the media asset data;
acquiring media presentation information signaling through the media asset transport channel, wherein the media presentation information signaling comprises a presentation information table and a component description table;
querying the media asset data based on the presentation information table and the component description table to acquire a data transport stream of the media asset data, wherein the data transport stream comprises media processing unit (MPU) metadata, fragment metadata, and media fragmentation unit (MFU) data;
detecting a transport sequence of the MPU metadata, the fragment metadata, and the MFU data in the data transport stream;
in response to the transport sequence being a target sequence, injecting the data transport stream into a player to cause the player to perform decoding and playing on the data transport stream in real time; and
in response to the transport sequence being not the target sequence, encapsulating the data transport stream as a media transport package based on the target sequence, and injecting the media transport package into the player.

12. The media asset playing method according to claim 11, further comprising:
monitoring a manipulation event of an upper-layer application;
in response to the manipulation event of switching a channel or accessing a channel, detecting a target channel accessed by a display apparatus;
querying the media asset data corresponding to the target channel; and
generating the playing command based on the media asset data.

13. The media asset playing method according to claim 11, further comprising: when acquiring the data transport stream of the media asset data,
calling a channel interface of a protocol stack middleware;
controlling a target channel accessed by the display apparatus through the channel interface; and
receiving the media presentation information signaling and media asset data of the target channel.

14. The media asset playing method according to claim 11, further comprising:
starting a media server of a protocol stack middleware;
establishing a connection relationship between the protocol stack middleware and the player through the media server; and
calling the player based on the connection relationship, and inject the data transport stream or the media transport package into the player.

15. The media asset playing method according to claim 11, further comprising: when decoding and playing the data transport stream,
initializing a decoder of the player;
decoding the data transport stream by the decoder; and
calling a underlying resource to render a playing picture of the media asset data on the display.

16. The media asset playing method according to claim 11, wherein the target sequence is the MPU metadata, the fragment metadata, and the MFU data in sequence.

17. The media asset playing method according to claim 11, further comprising:
in response to the playing command for the media asset data, receiving the data transport stream of the media asset data;
caching the data transport stream into a player cache region; and
in response to that the MPU metadata and the fragment metadata are cached in the player cache region, decapsulating data in the player cache region and inject the data in the player cache region into the player.

18. The media asset playing method according to claim 17, wherein the player cache region comprises a metadata cache region and a MFU data cache region, and the method further comprises: when the data transport stream is cached in the player cache region,
detecting a data type of data in the data transport stream;
in response to the data type being metadata, caching the metadata in the metadata cache region, wherein the metadata comprises the MPU metadata and the fragment metadata; and
in response to the data type being MFU data, caching the MFU data in the MFU data cache region.

19. The media asset playing method according to claim 11, further comprising: playing and displaying the MFU data after receiving the MPU metadata and the fragment metadata.

20. The media asset playing method according to claim 18, further comprising: when the data type of data in the data transport stream is neither metadata nor MFU data and the metadata received in the player cache region is not complete, discarding the data in the data transport stream.
